(19) United States
(12) Patent Application Publication
(10) Pub. No.: US 2025/0302217 A1
(43) Pub. Date: Oct. 2, 2025

(54) LIQUID IMAGE STAMPING ARRANGEMENT AND DESIGN METHOD

(71) Applicant: Ted Frumkin, Herzeliya (IL)

(72) Inventor: Ted Frumkin, Herzeliya (IL)

(21) Appl. No.: 18/862,973

(22) PCT Filed: May 24, 2023
(86) PCT No.: PCT/IL2023/050542

§ 371 Date: Nov. 5, 2024

Related U.S. Application Data
(60) Provisional application No. 63/365,332, filed on May 26, 2022.

(51) Int. Cl. A47G 19/22; A47G 23/03; G09F 23/08

(52) U.S. Cl. CPC A47G 19/2227; A47G 19/2255; A47G 23/0306; G09F 23/08

(57) ABSTRACT

A liquid image stamping arrangement stamps support surfaces with liquid imagery with a primary goal of providing a simple form of advertising. The liquid image stamping arrangement is usable in combination with containers of virtually any shape, dimension, and material construction, whether open or sealed. Liquid firstly positioned at an exterior container surface is secondly directed downwardly through a drainage portion to particularly deposit the liquid upon an image support surface for forming liquid imagery. The liquid may be in the form of condensate or overflow/spillage. The stamping arrangement provides a material construction that utilizes the inherent properties of the liquid to particularly direct and deposit liquid adjacent containers such that when the container is lifted from the surface a distinct image is revealed. The stamping arrangement may be integrally formed with a container or removably engaged with or attached to the container.

### TECHNOLOGICAL FIELD

The presently disclosed subject matter generally relates to container-based advertising. More particularly, the presently disclosed subject matter relates to a liquid stamping arrangement for a liquid container whereby advertising imagery is deposited in liquid form upon an image support surface.

### BACKGROUND

The art of advertising is ancient with its origins being traced to ancient Egypt, Greece and Rome. It became a major force in capitalist economies in the mid-19^{th} century with the advent of newspapers and magazines at which time soft drink and beer producers began promoting their products therewith. Advertising then grew rapidly in the 20^{th} century as new technology such as direct mail, radio, television, the Internet and mobile devices were developed. In present day, advertising is ubiquitous and can take many different forms, both blatant and subtle. Producers of products seeking growth in the market continue to seek novel and interesting ways to promote their products by way of various advertising methods. Beverage producers are one of the leading groups who promote their products through advertising and brand development. Beverage companies, in particular, for example, have been known to place thermochromic ink on labeling to provide a color changes upon the labeling to help consumers identify whether a beverage container is at a preferred temperature.

### GENERAL DESCRIPTION

The presently disclosed subject matter attempts to harness the use of both condensation collection as well as wetted exterior container surfacing caused by overflow or spillage, intentional or not, directed (e.g., when a bartender pours a beverage while tilting the glass) or not to provide a novel mechanism for forming liquid imagery associated with liquids of all viscosities, but beverages (e.g., soft drinks and alcoholic beverages) or water in particular. The liquid imagery provided by the presently disclosed subject matter can be used as a source indicator or for amusing effect as described in more detail hereinafter. In other words, the presently disclosed subject matter provides an apparatus and method for marking image support surfaces with liquid imagery with a primary goal of providing a simple form of advertising logos and the like, although the system and method may be utilized to mark any number of images upon the support surface. The apparatus and method according to the present disclosure is usable in combination with any container capable of accumulating condensate or subject to contents overflow or spillage.

In some embodiments, the containers usable in combination with the presently disclosed subject matter are liquid containers. The containers, however, can be of virtually any shape, dimension, and material construction, whether open or sealed. In some embodiments, the difference in temperature between the liquid container and the surrounding air containing moisture creates condensation, which collects into condensate and drains from the container to create a liquid image sized and shaped into a predetermined, distinct, and recognizable outline. In some embodiments, liquids from within containers that overflow or spill from the containers can be directed to also create a liquid image. In some embodiments, liquid may be stored by the presently disclosed subject matter leaving no image behind upon the support surface.

In some embodiments, the presently disclosed subject matter can be used in combination with glass, plastic, or metallic liquid containers including but not limited to bottles, cups, and cans. The liquid imagery provided can be in the form of virtually any shape, included various logos, drawings, numbers, and letters. The imagery shape is not random or simply reflective of a container support interface, but particularly configured to present a predetermined, recognizable, and distinct outline. In some embodiments, the presently disclosed subject matter can be provided as an add-on to the product, such as a cup holder. In certain other embodiments, the presently disclosed subject matter can be integrally formed with a liquid container. Liquid may be directed to form imagery deriving from liquid containers of all shapes and sizes and in some embodiments may derive from specific portions of a given liquid container. Further, in some embodiments, liquid may derive from either inside the liquid container or outside the liquid container.

In some embodiments, the directed liquid can leave logos/drawings on an image support surface that supports the liquid container and in other embodiments, the directed liquid can provide liquid imagery directly on the liquid container. In still other embodiments, the presently disclosed subject matter may deposit liquid imagery on liquid color changing materials such as cup coasters and the like. According to the teachings of the present disclosure there is also provided a liquid image marking or stamping method primarily designed with a view toward providing a novel advertising method, basically including the steps of providing a liquid container with liquid flowing on or from it, directing the liquid to the desired location or confluence zone according to the hydrodynamic properties of the liquid, and forming an image of any kind from the liquid. The present disclosure further provides a method of designing an liquid image stamp or arrangement as is described in more detail hereinafter.

There is thus provided in accordance with an embodiment of the presently disclosed subject matter a liquid image stamping arrangement for a container. The container is configured to hold a substance while being placed upon an image support surface. Whereby said arrangement, liquid having cohesive and adhesive properties firstly positioned at an exterior container surface of the container is configured to be secondly directed through utilization of its cohesive and adhesive properties by the arrangement to form an imagery from the liquid on the image support surface, beneath said container, when the container is placed thereupon such that the imagery comprises a predetermined, distinct, and recognizable outline.

In some embodiments, the container has a longitudinal axis oriented vertically when the container is uprightly placed on the image support surface, and a radial axis extending perpendicularly to the longitudinal axis. In some embodiments, the liquid image stamping arrangement comprises a drainage portion and a stamping portion. The drainage portion is configured to extend at least partially along the longitudinal axis of the container so as to utilize at least one of said properties to drain the liquid positioned on the exterior container surface to at least one predetermined confluence zone. The stamping portion has a shape corresponding to the distinct and recognizable outline, and is configured to extend at least partially along the radial axis of the container, and therebeneath, so as to utilize at least one of the properties of the liquid to direct the liquid from the confluence zone along the outline, so as to form the imagery thereby.

In some embodiments, the liquid image stamping arrangement comprises a bottom image support surface, configured to be placed directly beneath the container, facing the image support surface on which the liquid image stamping arrangement is placed. In some embodiments, the confluence zone spans, at least in part, along the bottom image support surface. In some embodiments, the drainage portion comprises hydrophobic surfaces while the stamping portion comprises hydrophilic surfaces. A hydrophilic material is one whose interactions with water and other polar substances are more thermodynamically favorable than their interactions with non-polar materials such as oil or other hydrophobic solvents. They are typically charge-polarized and capable of hydrogen bonding.

Hydrophobic interactions are mostly characterized by an entropic effect originating from the disruption of the highly dynamic hydrogen bonds between molecules of liquid water by the nonpolar solute, causing the water to form a lattice-like structure around the non-polar molecules. Surface energy interactions between the liquid and opposed surfacing of a particular geometry and/or texture, including but not limited to degrees of roughness of the surface, direct liquid along the surface(s) in some embodiments. In some embodiments, the liquid is directed, at least in part, by capillary action or surface energy interactions between liquid and liquid-to-surface interfaces to move the liquid along a surface configured to direct liquid flow. With aqueous liquids, this action is governed, in part, by the cohesive and/or adhesive properties of the liquid. Accordingly, in some embodiments, at least one of a hydrophilic material and a hydrophobic material is operable to at least direct and/or shape the liquid.

In some embodiments, the stamping portion protrudes from the bottom image support surface. In some embodiments, the liquid image stamping arrangement comprises at least one stabilizer element configured to stabilize the liquid image stamping arrangement along with the container when they are placed on the image support surface. The stabilizer element(s) define a support plane adjacent the support surface, on which the container along with said arrangement is configured to rest. When the arrangement along with the container are placed on the image support surface, the stamping portion is disposed at a height with respect to the support plane being identical to the support plane or slightly above it, so as to allow liquid applied on the stamping portion to spontaneously pass through the support plane to the image support surface, when the arrangement is placed on the image support surface. In some embodiments, the stabilizer elements constitute a part of the stamping portion. In some embodiments, the stabilizer element(s) protrude from the bottom image support surface, and the stamping portion is asymmetric.

In some embodiments, the drainage portion comprises tunnels extending from the at least one confluence zone. In some embodiments, the distinct and recognizable outline is asymmetric. In some embodiments, the stamping portion is non-continuous comprising at least one gap between two adjacent non-continuous portions thereof, which gaps have a width being no greater than 10 mm, particularly, 5 mm, and yet more particularly, 2 mm. In some embodiments, the gaps may comprise a hydrophobic surface. In some embodiments, the stamping portion is flat while in certain other embodiments, the stamping portion comprises at least one rim having a shape corresponding to at least a portion of the distinct and recognizable outline.

In some embodiments, the liquid image stamping arrangements comprise a liquid outlet having a shape corresponding to the distinct and recognizable outline, so as to shape liquid outletting therethrough for forming the imagery, the outlet being constituted by a through opening in a surface of the arrangement. In some embodiments, the at least one stabilizer element is configured to at least partially surround the liquid outlet. In some embodiments, the stabilizer elements are configured to elevate the container relative to the liquid outlet at a container support plane parallel to the support surface.

In some embodiments, the liquid outlet comprises at least one peripheral rim configured to face the support surface when the arrangement along with the container is placed thereon, the peripheral rim constituting at least a part of the stamping portion. In some embodiments, the stabilizer elements are configured to cooperate with the peripheral rim to stabilize said arrangement along with the container upon the support surface. In some embodiments, the peripheral rim comprises a hydrophobic surface, while the rest of the liquid outlet comprises a hydrophobic surface fluidly connected to or in fluid communication with the peripheral rim.

In some embodiments, the drainage portion may comprise at least one of a ridge, a valley, a channel, a sloped surface, a tunnel, and a textured surface configured to direct liquid therealong. In some embodiments, the at least one of said ridge, said valley, said channel, said sloped surface, said tunnel, and said textured surface is formed at an exterior surface of the drainage portion. In some embodiments, the drainage portion comprises a tunnel extending at least partially along the longitudinal axis of the container, having an opening facing the stamping portion. In some embodiments, the tunnel extends also at least partially along the radial axis so as to direct liquid from a side surface of the arrangement to the stamping portion.

In some embodiments, the stabilizer elements may comprise at least one container stabilizer arm configured to extend upwardly from the drainage portion for engaging a side surface of the container so as to direct liquid therefrom to the stamping portion. In some embodiments, the arrangement may comprise a series of container stabilizer arms peripherally spaced about a periphery of the drainage portion for peripherally stabilizing the container. In some embodiments, at least one container stabilizer arm is resiliently actuable for resiliently engaging the container. In some embodiments, at least one container stabilizer arm comprises a ridged surface configured to grip the exterior container surface for enhancing stability of the container when engaged therewith. In some embodiments, the stabilizer elements and/or stabilizer arms are integrally formed with the drainage portion.

In some embodiments, the drainage portion comprises an image-defining element connected thereto by way of at least one bridge element. In some embodiments, the bridge element is configured above the support plane when the arrangement along with the container is placed on the image support surface. In some embodiments, the bridge elements are configured so as direct liquid therealong to the stamping portion. In some embodiments, the image-defining element comprises an element periphery, the element periphery being hydrophilic for attracting aqueous liquid thereto. In some embodiments, the image-defining element is connected to the liquid outlet by means of at least one bridge element, for providing an inner image and an outer image upon the support surface.

In some embodiments, the inner image is the same shape as the outer image and centered relative thereto. In some embodiments, the bride element has a length of no more than 10 mm, particularly, 5 mm, and yet more particularly 2 mm. In some embodiments, the liquid image stamping arrangements are integrally formed with the container and configured to receive liquid for directing liquid therethrough. In some embodiments, the liquid image stamping arrangements are removably engageable with the container and configured to receive the liquid for directing liquid therethrough. In some embodiments, the imagery formed from liquid deposition upon the support surface is an advertising logo.

Noting that the presently disclosed subject matter further contemplates corresponding methodology, there is further provided in accordance with another embodiment of the present subject matter a liquid image stamp design process. The liquid image stamp design process is for a liquid image stamp for a container configured to hold a substance while being placed upon a support surface. Whereby a liquid image stamp, liquid having cohesive and adhesive properties firstly positioned at an exterior container surface of the container is configured to be secondly directed through utilization of its cohesive and adhesive properties by the liquid image stamp to form an imagery from the liquid on the support surface, beneath said container, when the container is placed thereupon. The imagery comprises a predetermined, distinct, and recognizable outline. The liquid image stamp design process comprises the steps of: selecting an image shape; designing a stamping portion configured with a corresponding shape to the image shape; designing at least one confluence zone adjacent the stamping portion from which liquid can be directed to the stamping portion; and designing a drainage portion for directing liquid to the at least one confluence zone.

In some embodiments, the container has a longitudinal axis oriented vertically when the container is uprightly placed on the image support surface, and a radial axis extending perpendicularly to the longitudinal axis. In some embodiments, the drainage portion is configured to extend at least partially along the longitudinal axis of the container so as to utilize at least one of said properties to drain the liquid positioned on the exterior container surface to at least one predetermined confluence zone. The stamping portion has a shape corresponding to the distinct and recognizable outline in some embodiments, and is configured to extend at least partially along the radial axis of the container, and therebeneath, so as to utilize at least one of the properties of the liquid to direct the liquid from the confluence zone along the outline, so as to form the imagery thereby.

In some embodiments, the liquid image stamp comprises a bottom image support surface, configured to be placed directly beneath the container, facing the image support surface on which the liquid image stamp is placed. In some embodiments, the confluence zone spans, at least in part, along the bottom image support surface. In some embodiments, the drainage portion comprises hydrophobic surfaces while the stamping portion comprises hydrophilic surfaces. It will be recalled a hydrophilic material is one whose interactions with water and other polar substances are more thermodynamically favorable than their interactions with non-polar materials such as oil or other hydrophobic solvents. They are typically charge-polarized and capable of hydrogen bonding and surface energy levels at the liquid-to-surface interface may direct the liquid accordingly.

In some embodiments, the stamping portion protrudes from the bottom image support surface. In some embodiments, the liquid stamp design comprises at least one stabilizer element configured stabilize the liquid image stamp along with the container when they are placed on the image support surface. The stabilizer element(s) define a support plane adjacent the support surface, on which the container along with said arrangement is configured to rest. When the liquid image stamp along with the container are placed on the image support surface, the stamping portion is disposed at a height with respect to the support plane being identical to the support plane or slightly above it, so as to allow liquid applied on the stamping portion to spontaneously pass through the support plane to the image support surface, when the liquid image stamp is placed on the image support surface. In some embodiments, the stabilizer elements constitute a part of the stamping portion. In some embodiments, the stabilizer element(s) protrude from the bottom image support surface. In some embodiments, the stamping portion is asymmetric.

In some embodiments, the drainage portion comprises tunnels extending from the at least one confluence zone. In some embodiments, the distinct and recognizable outline is asymmetric. In some embodiments, the stamping portion is non-continuous, comprising at least one gap between two adjacent non-continuous portions thereof, with a gap width being no greater than 10 mm, particularly, 5 mm, and yet more particularly, 2 mm. In some embodiments, the gap may comprise a hydrophobic surface. In some embodiments, the stamping portion is flat while in certain other embodiments, the stamping portion comprises at least one rim having a shape corresponding to at least a portion of the distinct and recognizable outline.

In some embodiments, the liquid image stamp comprises a liquid outlet having a shape corresponding to the distinct and recognizable outline, so as to shape liquid outletting therethrough for forming the imagery, the outlet being constituted by a through opening in a surface of the arrangement. In some embodiments, the at least one stabilizer element is configured to at least partially surround the liquid outlet. In some embodiments, the stabilizer element is configured to elevate said container relative to the liquid outlet at a container support plane parallel to the support surface.

In some embodiments, the liquid outlet comprises at least one peripheral rim configured to face the support surface when the liquid image stamp along with the container is placed thereon, the peripheral rim constituting at least a part of the stamping portion. In some embodiments, the stabilizer elements are configured to cooperate with the peripheral rim to stabilize said liquid image stamp along with the container upon the support surface. In some embodiments, the peripheral rim comprises a hydrophobic surface, while the rest of the liquid outlet comprises a hydrophobic surface fluidly connected to the peripheral rim.

In some embodiments, the drainage portion may comprise at least one of a ridge, a valley, a channel, a sloped surface, a tunnel, and a textured surface configured to direct liquid therealong. In some embodiments, the at least one of said ridge, said valley, said channel, said sloped surface, said tunnel, and said textured surface is formed at an exterior surface of said drainage portion. In some embodiments, the drainage portion comprises a tunnel extending at least partially along the longitudinal axis of the container, having an opening facing the stamping portion. In some embodiments, the tunnel extends also at least partially along the radial axis, so as to direct liquid from a side surface of the liquid image stamp to the stamping portion.

In some embodiments, the stabilizer elements may comprise at least one container stabilizer arm configured to extend upwardly from the drainage portion for engaging a side surface of the container, so as to direct liquid therefrom to the drainage portion. In some embodiments, the liquid image stamp may comprise a series of container stabilizer arms peripherally spaced about a periphery of the drainage portion for peripherally stabilizing the container. In some embodiments, at least one container stabilizer arm is resiliently actuable for resiliently engaging the container. In some embodiments, at least one container stabilizer arm comprises a ridged surface configured to grip the exterior container surface for enhancing stability of the container when engaged therewith. In some embodiments, the stabilizer elements are integrally formed with the drainage portion.

In some embodiments, the drainage portion comprises an image-defining element connected thereto by way of at least one bridge element. In some embodiments, the bridge element is configured above the support plane when the liquid image stamp along with the container is placed on the image support surface. In some embodiments, the bridge elements are configured so as direct liquid therealong to the stamping portion. In some embodiments, the image-defining element comprises an element periphery, the element periphery being hydrophilic for attracting aqueous liquid thereto. In some embodiments, the image-defining element is connected to the liquid outlet by means of at least one bridge element, for providing an inner image and an outer image upon the support surface.

In some embodiments, the inner image is the same shape as the outer image and centered relative thereto. In some embodiments, the bride element has a length of no more than 10 mm, particularly, 5 mm, and yet more particularly 2 mm. In some embodiments, the liquid image stamp is integrally formed with the container and configured to receive liquid for directing liquid therethrough. In some embodiments, the liquid image stamp is removably engageable with the container and configured to receive the liquid for directing liquid therethrough. In some embodiments, the imagery formed from liquid deposition upon the support surface is an advertising logo.
According to yet another aspect of the presently disclosed subject matter, there is provided a container configured to hold a substance, incorporating a collection arrangement whereby liquid having cohesive and adhesive properties firstly placed on an exterior surface of said container can be collected to prevent staining of a support surface on which said container is configured to be placed, the container having a longitudinal axis oriented vertically when the container is uprightly placed on the support surface, and a radial axis extending perpendicularly to said longitudinal axis;
   said liquid collecting arrangement comprises:
      a collection portion spanning at least partially along said radial axis, configured to enable accumulation of said liquid therein; and
         a drainage portion extending at least partially along said longitudinal axis and utilize at least one of said properties to drain the liquid positioned on the exterior container surface to the collection portion.

Said drainage portion can extend along the exterior container surface.

Said container can have an upper container volume in which liquid can be normally stored, and a lower container volume disposed directly therebeneath, defined by the collection arrangement.

### BRIEF DESCRIPTION OF THE DRAWINGS

Other features and objectives of the presently disclosed subject matter will become more evident from a consideration of the following brief descriptions of drawings submitted in support of these specifications.

FIG. 1 is a bottom view of a basic first liquid image stamping mechanism according to the present disclosure.

FIG. 2 is a top side perspective view of the basic first liquid image stamping mechanism according to the present disclosure.

FIG. 3A is a top side perspective view of the basic first liquid image stamping mechanism supporting a bottle type liquid container depicting liquid upon an exterior container surface being directed downwardly toward the basic liquid image stamping mechanism.

FIG. 3B is a top side perspective view of the basic first liquid image stamping mechanism supporting a cup type liquid container depicting liquid upon an exterior container surface being directed downwardly toward the basic liquid image stamping mechanism.

FIG. 4 is a top plan view of a basic liquid image formed upon an image support surface from the basic first liquid image stamping mechanism otherwise presented in FIG. 1.

FIG. 4A is a perspective depiction of the basic liquid image formed upon the image support surface of a table top as revealed by removing the basic first liquid image stamping mechanism shown adjacent the basic liquid image.

FIG. 5 is a perspective view of a basic second liquid image stamping mechanism according to the present disclosure showing a plurality of liquid-directing tunnels extending from an exterior surface of the arrangement to the bottom of the arrangement.

FIG. 6 is a side elevational schematic depiction of a liquid container supported atop a third liquid image stamping mechanism with a series of stabilizer elements according to the present disclosure.

FIG. 6A is a side elevational schematic depiction of a liquid container supported atop the third liquid image stamping mechanism with the series of stabilizer elements and a peripheral rim element extending downwardly from a main body of the arrangement, the peripheral rim element having a height equal to a height of opposed surface stabilizer elements.

FIG. 6B is a side elevational schematic depiction of a liquid container supported atop the third liquid image stamping mechanism with the series of stabilizer elements and a peripheral rim element extending downwardly from a main body of the arrangement, the peripheral rim element having a height less than a height of the opposed surface stabilizer elements.

FIG. 7 is a top perspective view of a fourth liquid image stamping mechanism according to the present disclosure showing a centralized heart-shaped liquid outlet.

FIG. 8 is a bottom perspective view of the fourth liquid image stamping mechanism according to the present disclosure showing the centralized heart-shaped liquid outlet.

FIG. 9 is a top perspective view of a fifth liquid image stamping mechanism according to the present disclosure showing a centralized star-shaped liquid outlet.

FIG. 10 is a top perspective view of a sixth liquid image stamping mechanism according to the present disclosure showing both a centralized star-shaped liquid outlet and a series of letter-shaped liquid outlets arranged to denote a first famous trademark.

FIG. 11 is a bottom perspective view of the sixth liquid image stamping mechanism according to the present disclosure.

FIG. 12 is a top perspective view of a seventh liquid image stamping mechanism according to the present disclosure showing a centralized liquid outlet formation configured to stamp a second famous trademark.

FIG. 13 is a bottom perspective view of the seventh liquid image stamping mechanism according to the present disclosure.

FIG. 14 is a top plan view of an eighth liquid image stamping mechanism according to the present disclosure showing the centralized liquid outlet formation configured to stamp the second famous trademark.

FIG. 15 is a top perspective view of the eighth liquid image stamping mechanism according to the present disclosure.

FIG. 16 is a top perspective view of a ninth liquid image stamping mechanism according to the present disclosure.

FIG. 17 is a bottom perspective view of the ninth liquid image stamping mechanism according to the present disclosure.

FIG. 17A is a bottom perspective view of a tenth liquid image stamping mechanism according to the present disclosure.

FIG. 18 is a top perspective view of the tenth liquid image stamping mechanism according to the present disclosure.

FIG. 19 is a fragmentary longitudinal sectional view of an eleventh liquid image stamping mechanism according to the present disclosure sectioned to show in greater detail a first sloped upper surface of a main body thereof.

FIG. 20 is a fragmentary longitudinal sectional perspective view of a twelfth liquid image stamping mechanism according to the present disclosure sectioned to show in greater detail a second sloped upper surface of a main body thereof.

FIG. 21 is a first top perspective view of the twelfth liquid image stamping mechanism according to the present disclosure.

FIG. 22 is a second top perspective view of the twelfth liquid image stamping mechanism according to the present disclosure.

FIG. 23 is an enlarged fragmentary bottom perspective view of a bottom portion of the twelfth liquid image stamping mechanism according to the present disclosure enlarged to show in greater detail structural features thereof.

FIG. 24 is a first enlarged fragmentary top perspective view of a top portion of the twelfth liquid image stamping mechanism according to the present disclosure enlarged to show in greater detail structural features thereof.

FIG. 25 is a second enlarged fragmentary top perspective view of a top portion of the twelfth liquid image stamping mechanism according to the present disclosure enlarged to show in greater detail structural features thereof.

FIG. 26 is a top perspective view of a thirteenth liquid image stamping mechanism according to the present disclosure.

FIG. 27 is a top perspective view of a fourteenth liquid image stamping mechanism according to the present disclosure.

FIG. 28 is a first top perspective view of a first combination liquid image stamping arrangement according to the present disclosure.

FIG. 29 is a bottom perspective view of the first combination liquid image stamping arrangement according to the present disclosure.

FIG. 30 is a top perspective view of an alternative first combination liquid image stamping arrangement according to the present disclosure.

FIG. 31 is an enlarged fragmentary perspective view of an alternative bottom portion of the first combination liquid image stamping arrangement according to the present disclosure.

FIG. 32 is a top perspective view of a second combination liquid image stamping arrangement according to the present disclosure.

FIG. 33 is a bottom perspective view of the second combination liquid image stamping arrangement according to the present disclosure.

FIG. 34 is a bottom perspective view of a third combination liquid image stamping arrangement according to the present disclosure.

FIG. 35 is a first side elevational view of the third combination liquid image stamping arrangement according to the present disclosure.

FIG. 36 is a second side elevational view of the third combination liquid image stamping arrangement according to the present disclosure.

FIG. 37 is a bottom perspective view of a fourth combination liquid image stamping arrangement according to the present disclosure.

FIG. 38 is a top perspective view of the fourth combination liquid image stamping arrangement according to the present disclosure.

FIG. 39 is a top perspective view of a fifth combination liquid image stamping arrangement according to the present disclosure.

FIG. 40 is a bottom plan view of the fifth combination liquid image stamping arrangement according to the present disclosure.

FIG. 41 is a fragmentary perspective view of a bottom portion of the fifth combination liquid image stamping arrangement according to the present disclosure.

FIG. 42 is a fragmentary perspective view of a bottom portion of a sixth combination liquid image stamping arrangement according to the present disclosure.

FIG. 43 is an enlarged fragmentary perspective view of the bottom portion of the sixth combination liquid image stamping arrangement according to the present disclosure enlarged to show in greater detail the bottom portion.

FIG. 44 is a top perspective view of a seventh combination liquid image stamping arrangement according to the present disclosure.

FIG. 45 is an enlarged fragmentary bottom perspective view of the seventh combination liquid image stamping arrangement according to the present disclosure enlarged to show in greater detail a bottom surface thereof.

FIG. 46 is a top perspective view of an eighth combination liquid image stamping arrangement according to the present disclosure.

FIG. 47 is a top perspective view of a ninth combination liquid image stamping arrangement according to the present disclosure.

FIG. 48 is a top perspective view of a tenth combination liquid image stamping arrangement according to the present disclosure.

FIG. 49 is a top perspective view of an eleventh combination liquid image stamping arrangement according to the present disclosure.

FIG. 50 is a bottom plan view of the eleventh combination liquid image stamping arrangement according to the present disclosure.

FIG. 51 is a bottom perspective view of a twelfth combination liquid image stamping arrangement according to the present disclosure.

FIG. 52 is a bottom perspective view of an alternative twelfth combination liquid image stamping arrangement according to the present disclosure.

FIG. 53 is an enlarged fragmentary bottom perspective view of bottom surface of combination liquid image stamping arrangement according to the present disclosure enlarged to show in greater detail a bottom surface thereof.

FIG. 54 is a top plan view of a liquid image formed upon an image support surface from the bottom surface otherwise depicted in FIG. 53.

### DETAILED DESCRIPTION OF THE EMBODIMENTS

The principles and operation of the liquid image stamping arrangement or apparatus and liquid stamp design process according to the presently disclosed subject matter may be better understood with reference to the drawings and the accompanying descriptions. The present disclosure provides a liquid image stamping apparatus or arrangement the author refers to as LIQUIAD. In some embodiments, the LIQUIAD image stamping arrangement and method facilitates the creation of advertising imagery, including logos, drawings, numbers, letters, etc. by directing liquid posited on an exterior container surface 11 of liquid containers 10 exemplified by bottles, glasses, and cans.

As earlier introduced, in some embodiments, the container need not be a liquid container 10, but a container having contents of differing temperature as compared to the ambient air in which the container is placed thereby enabling condensation collection or liquid collection at a select container surface, which may then be directed to form liquid imagery 12. For example, a container holding relatively warm contents may form condensate at an interior surface of the container. This internally located liquid posited upon the interior surface may be similarly directed to form liquid imagery 12 upon a liquid image support surface 102 according to the present disclosure.

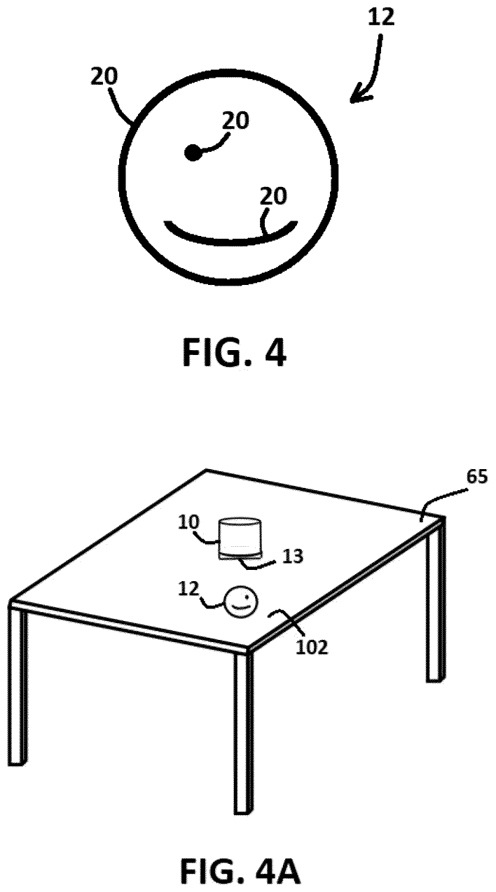

For purposes of illustration, however, the container is exemplified by a liquid container 10 configured to hold a liquid such as water or any aqueous solution (e.g., beverages). Liquid 105 formed or positioned at an exterior container surface 11 of a liquid container 10, for example, may be in the form of either condensate or overflow/spillage inherently having certain cohesive and adhesive properties. This liquid 105 may be directed a drainage portion having structural formations of chosen or select material construction that cooperate with these properties to direct the liquid 105 to a stamping portion and mark or stamp the liquid imagery 12 upon a support surface 102 such as a table top as at 65 in FIG. 4A.

In some embodiments, the present disclosure provides an innovative advertising mechanism that is created by both condensate and/or liquid collected on a container surface that may occur from either overflow or spillage. For example, when there is a difference in temperature between a relatively colder liquid container 10 and relatively warmer air surrounding the liquid container 10, condensation of humidity in the air will accumulate on the exterior container surface 11 of the liquid container 10. Alternatively, when there is a difference in temperature between a relatively warmer container and relatively cooler air surrounding the container, condensate may form on an interior container surface of the container. In the former example, the LIQUIAD image stamping arrangement may be outfitted upon the bottom of the liquid container 10, and liquid as at 105 may be dispersed or drained in the desired direction 106 thereby creating images of liquid or liquid imagery 12 on the support surface 102 including all surfaces on which the liquid container 10 is supported.

The term, “LIQUIAD” essentially refers to the apparatus or process for directing liquid 105 from liquid containers 10 to create liquid imagery 12 typically in the form of advertising or logos and similar other visual material with distinct and recognizable outlines. Directing liquid 105 can occur from the bottom of the liquid container 10 or from specific areas of the liquid container 10 or the entire liquid container 10 and may occur from both the interior and exterior of the liquid container 10 and also from both the interior and exterior of the liquid image stamping arrangements according to the present disclosure. The liquid image stamping arrangement can be integrally formed with the liquid container 10 or removably engaged with or attached thereto. It is contemplated that all types of shapes, materials, and liquid imagery can be implemented by applying hydrodynamic properties of materials that contact the liquid 105 and the specific arrangements thereof as the user may elect.

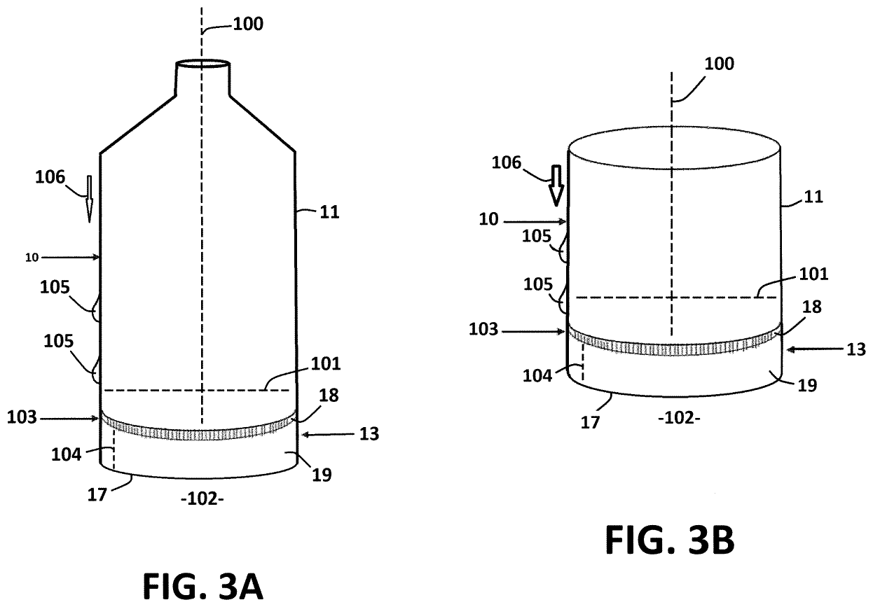

Referring now to the drawings with more specificity, the presently disclosed subject matter provides a liquid image stamping arrangement and associated liquid image stamp design methodologies for a container exemplified by a liquid container 10. The liquid container 10 according to the present disclosure may include bottles, cans, cups, glassware, bowls, casks and the like, and may further include open or sealed containers of varied material construction, including glass, metal, and plastic. A bottle type liquid container 10 is generally depicted and referenced in FIG. 3A and a cup type liquid container 10 is generally depicted in FIG. 3B for illustrative purposes only.

In some embodiments, the liquid container 10 according to the present disclosure essentially has a longitudinal axis as at 100 and a radial axis as at 101 that extends orthogonally relative to the longitudinal axis 100. When placed upon a support surface 102 such as a tabletop 65, desktop or countertop, the longitudinal axis 100 extends or is oriented vertically and the radial axis 101 extends or is oriented horizontally. The present disclosure is primarily designed with a view toward beverage applications involving aqueous beverages, such as soft drinks, alcoholic beverages, juices, and the like that are often set down upon such support surfaces 102 intermittently between moments of beverage consumption. It is noted that liquid containers 10 containing relatively cold beverages are often of a different temperature relative to the relatively warmer ambient temperature surrounding the liquid container 10, and are thereby prone to condensation formation on the exterior container surface 11.

Condensation or water droplets typically collect on the exterior container surface 11 when exposed to air laden with humidity. At liquid-air interfaces, surface tension results from the greater attraction of liquid molecules to each other (due to cohesion) than to the molecules in the air (due to adhesion). It is noted that water has one of the highest surface tension ratings among liquids due to inter-molecular hydrogen bonding. When condensation collects and the weight of the condensate meet a certain threshold, gravity may overcome the adhesive forces with the exterior container surface 11 and direct condensate or liquid 105 downwardly as at vector 106.

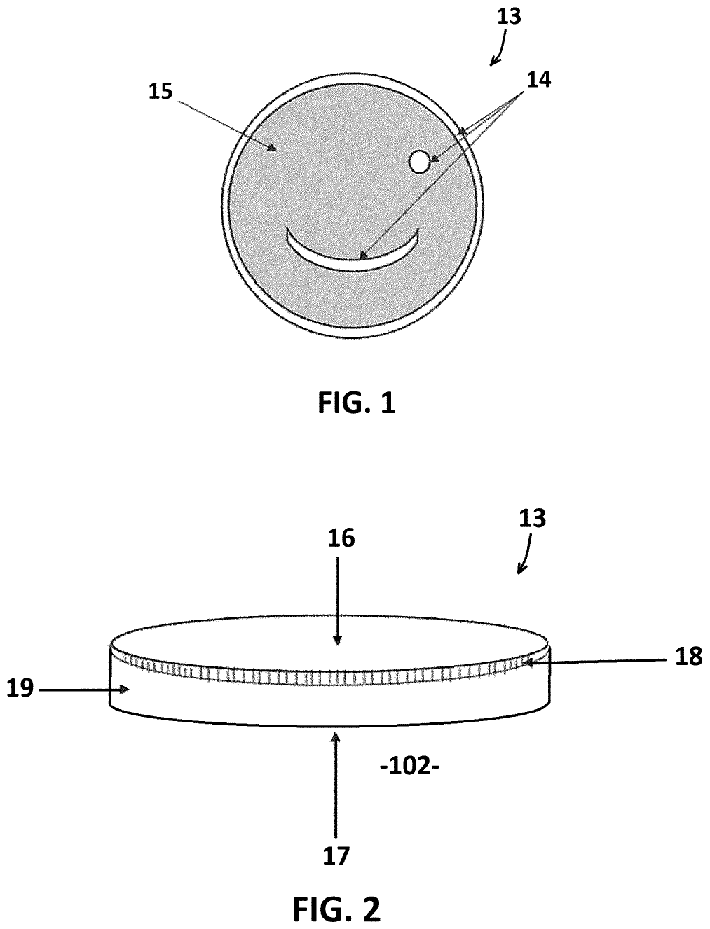

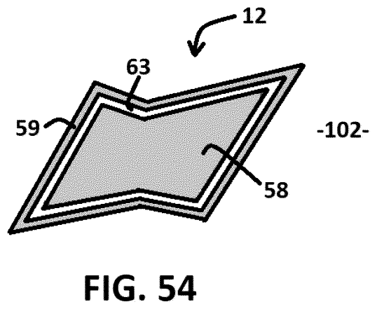

In addition to condensation collection on the exterior container surfaces 11, liquid containers 10 are also prone to overflow or spillage. In this regard, it is noted that both condensation formation and overflow or spillage may result in a downwardly directed liquid flow 106 along the exterior container surface 11. The present disclosure utilizes this natural phenomenon to create liquid imagery 12 by way of this directed liquid flow 106, and in certain embodiments provides a novel method to display advertising logos and the like during beverage consumption. The liquid imagery as at 12 comprises a predetermined, distinct, and recognizable outline as generally depicted in FIGS. 4, 4A, and 54. The simple ‘one-eyed smiley face’ liquid imagery 12 depicted in FIGS. 4 and 4A results from liquid deposition 20 upon the image support surface 102 by way of the various liquid image stamping arrangements presented in this disclosure. A first basic liquid image stamping arrangement or mechanism 13 is generally depicted in FIGS. 1-3B, and 4A.

According to some embodiments of the presently disclosed subject matter in which the stamping arrangement is integral with the container, as shown for instance in FIGS. 1 to 4A, the stamping arrangement can be a liquid collection arrangement, configured to merely collet the liquid placed on the exterior surface of the container to prevent it from staining the support surface on which the container along with the arrangement are placed, instead of facilitating stamping on the support surface. According to an example, the collection arrangement comprises all the features of the arrangement 13, yet with the bottom end 17 sealed to liquid, hence creating a liquid reservoir thereabove in which condensate liquid and spillage liquid can be collected.

Hence, in accordance with the presently disclosed subject matter, there is provided also a container configured to hold a substance, incorporating a collection arrangement whereby liquid having cohesive and adhesive properties firstly placed on an exterior surface of said container can be collected to prevent staining a support surface on which said container is configured to be placed.

The container having a longitudinal axis oriented vertically when the container is uprightly placed on the support surface, and a radial axis extending perpendicularly to said longitudinal axis; and wherein said liquid collecting arrangement comprises:
a collection portion spanning at least partially along said radial axis configured to enable accumulation of said liquid therein; and
a drainage portion configured to extend at least partially along said longitudinal axis and utilize at least one of said properties to drain the liquid positioned on the exterior container surface to the collection portion According to a particular example, the drainage portion can extend at least partially along the exterior container surface.

According to a particular example, the container has an upper container volume in which liquid can be normally stored, and a lower container volume disposed directly therebeneath, defined by the collection arrangement.

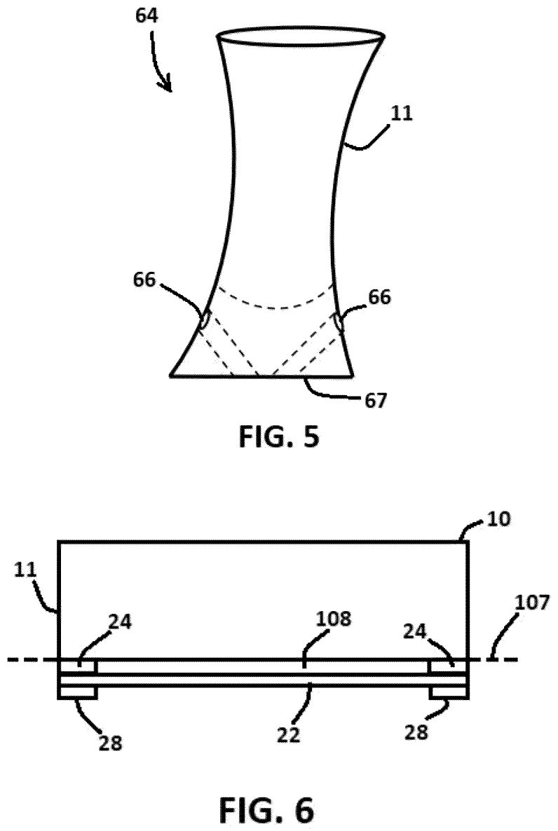

Referencing FIG. 1 the reader will there note hydrophilic liquid openings as at 14 where liquid deposition 20 occurs and a hydrophobic dry region as at 15 wherein liquid is prevented from entering. This essentially provides a stamping arrangement or liquid image stamp for marking or stamping liquid imagery 12 upon a support surface 102. In some embodiments, the drainage portions according to the present disclosure comprise at least one of a ridge, a valley, a channel, a sloped surface, a hole or tunnel as at 66, or textured surfacing. The tunnels 66 extend from an exterior container surface 11 to an arrangement bottom 67 as with liquid image stamping arrangement 64 depicted in FIG. 5.

In some embodiments, the drainage portion comprises tunnels 66 extending from the at least one confluence zone located at the arrangement bottom 67 in FIG. 5. In some embodiments, the drainage portion comprises a tunnel 66 extending at least partially along the longitudinal axis 100 of the container 100, having an opening facing the stamping portion at the arrangement bottom 67. In some embodiments, the tunnel(s) 66 extends also at least partially along the radial axis, so as to direct liquid from a side surface of the arrangement to the stamping portion. In this regard, it is noted that the tunnels 66 are obliquely angled relative to the longitudinal and radial axes 100 and 101, respectively.

The liquid image stamping arrangement 64 depicts a basic all-in-one or combination liquid image stamping arrangement according to the present disclosure. Structural formations including ridges, valleys, channels, sloped surfaces, holes, tunnels 66 and textured surfacing are configured to direct liquid therealong to bolster liquid image formation upon the image support surface 102 as described in more detail hereinafter. In some embodiments, these structural features are formed at or are in fluid communication with an exterior surface of the various liquid image stamping arrangements according to the present disclosure.

The liquid image stamping arrangement or mechanism 13 depicted in FIGS. 1 through 3B and 4A includes an upper end 16, a bottom end 17, a liquid inlet 18, and a raised stabilizer element 19. A liquid container 10 may be removably supported atop the upper end 16 as generally and comparatively depicted in FIGS. 3A and 3B. In some embodiments, the liquid container 10 may be connected to the liquid image stamping arrangements. Liquid as at 105 travels downwardly as at vector 106 along the exterior container surface 11 and is re-directed as at vector 103 into the liquid inlet 18 from the exterior container surface 11 of the liquid container 10. In some embodiments, at least one stabilizer element (as at stabilizer element 19) is configured to at least partially surround the liquid outlet(s) defined by openings 14 in this embodiment.

The inletting liquid travels by an internal pathway 104 to the liquid openings 14 for liquid deposition 20 upon the support surface 102. The liquid depositions 20 result in the liquid imagery 12 generally depicted in FIGS. 4 and 4A. The circular outer liquid deposition 20 of the liquid imagery 12 shown in FIG. 4 derives from the circular outer channel-like liquid opening 14; the arcuate inner liquid deposition 20 of the liquid imagery 12 derives from the arcuate inner channel-like liquid opening 14; and the singular inner circular liquid deposition 20 of the liquid imagery 12 derives from a circular aperture liquid opening 14. The openings 14 are in fluid communication liquid inlet 18 via the internal pathway 104.

A hydrophilic support surface 102 will generally result in better wetting action at the deposition site with a relatively wider deposition spread and a relatively reduced liquid thickness. A hydrophobic support surface 102 will generally result in poorer wetting action at the deposition sites with a relatively narrower deposition spread and a relatively increased liquid thickness. The support surface 102 material, whether smooth, rough, or of a given porosity may affect characteristics of the liquid imagery 12. A hydrophilic material or molecule is one whose interactions with water and other polar substances are more thermodynamically favorable than their interactions with non-polar materials such as oil or other hydrophobic solvents. They are typically charge-polarized and capable of hydrogen bonding. Hydrophobic interactions are mostly characterized by an entropic effect originating from the disruption of the highly dynamic hydrogen bonds between molecules of liquid water by the nonpolar solute, causing the water to form a lattice-like structure around the non-polar molecules. Entropy is central to the second law of thermodynamics, which states that the entropy of an isolated system left to spontaneous evolution cannot decrease with time, as they always arrive at a state of thermodynamic equilibrium where the entropy is highest. Liquid-surface interactions will thus depend on a number of different factors, including, but not limited to degrees of roughness of the surface(s) and the surface energy levels associated therewith.

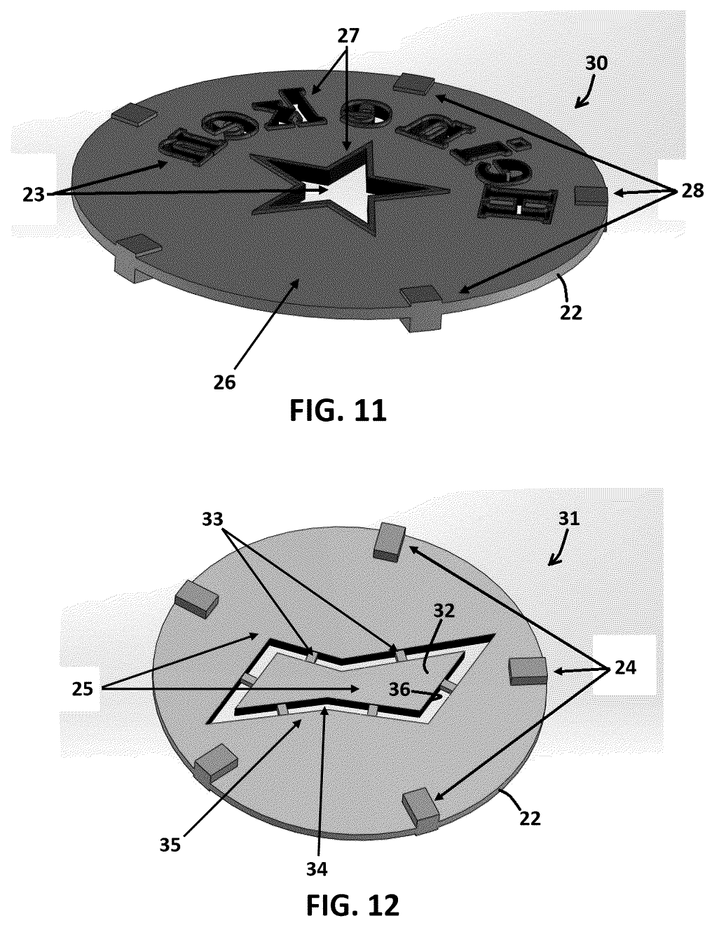

In some embodiments, the liquid image stamping arrangements comprise a stabilizing portion. Examples of this include a raised stabilizer element 19, container stabilizer elements 24, and surface stabilizer elements 28. In some embodiments, the stabilizer elements 28 constitute a part of the stamping portion and protrude from a bottom image support surface 26. In some embodiments, the stamping portion and the corresponding distinct and recognizable outline are asymmetric as generally depicted with liquid image stamping arrangement 30 in FIGS. 10 and 11. In some embodiments, stabilizer elements 76 extend downwardly from a container bottom portion as generally depicted in FIG. 51.

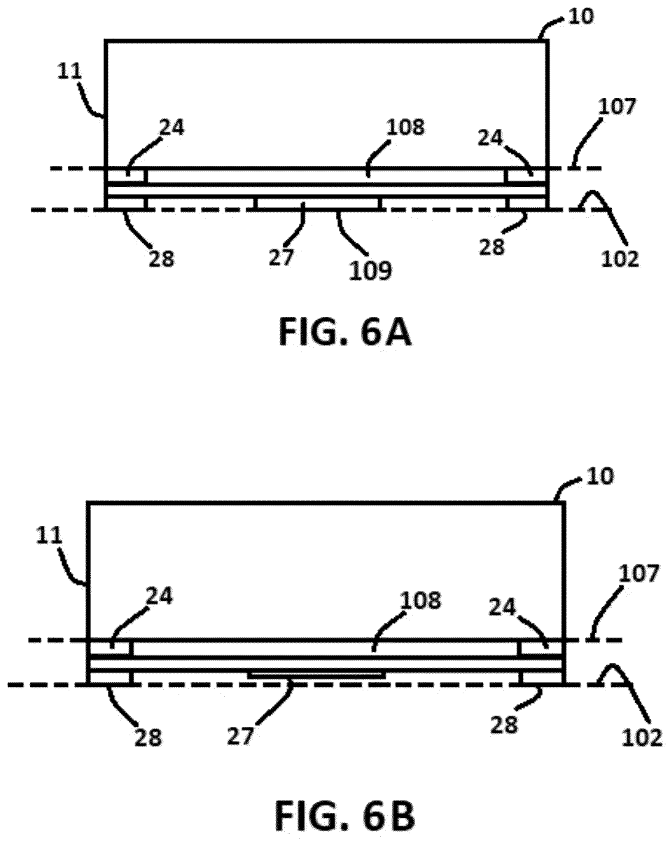

The stabilizer portion at least partially surrounds a stamping portion, to provide stability thereto in some embodiments and may be uniformly configured or non-uniformly configured depending on the contours of the container. In some embodiments, the container 10 may comprise a stabilizer portion as is the case with the embodiment depicted in FIG. 51. In some embodiments, the stabilizing portion defines a support plane as at 107 on which the liquid container 10 rests while the ensemble is placed on the support surface 102 in some embodiments as schematically depicted in FIGS. 6 through 6B.

In some embodiments, the stabilizer elements 24 are configured to elevate the container 10 relative to the liquid outlet 23 at the container support plane 107 parallel to the support surface 102. In some embodiments, the liquid image stamping arrangements comprise a liquid outlet 23 having a shape corresponding to the distinct and recognizable outline, so as to shape liquid outletting therethrough for forming the imagery, the liquid outlet 23 being constituted by a through opening in a surface of the arrangement as is illustrated and referenced in at least liquid image stamping arrangements 21, 29, 31, 37, 42 and 44.

In some embodiments, the stamping portion comprises a peripheral rim 27 that extends about a liquid outlet periphery of a liquid outlet 23. In some embodiments, the stamping portion comprises at least one peripheral rim 27 having a shape corresponding to at least a portion of the distinct and recognizable outline. In some embodiments, the stamping portion in the form of a peripheral rim 27, protrudes from the bottom image support surface 26. In some embodiments, the stamping portion or peripheral rims 27 are of a height that is identical to the height of the surface stabilizer elements 28 as generally depicted in FIG. 6A.

In some embodiments, the stabilizer elements 28 are configured to cooperate with the peripheral rim 27 to stabilize the arrangement along with the container 10 upon the support surface 102. In some embodiments, the stamping portion or peripheral rims 27 are of a height that is lesser than the height of the surface stabilizer elements 28 as generally depicted in FIG. 6B. Liquid attracted to the confluence zone as at 108 can spontaneously move to the support surface 102 via a liquid outlet 23. In some embodiments, the confluence zone 108 spans, at least in part, along the bottom image support surface 26. In some embodiments, the peripheral rim 27 comprises a hydrophobic surface, while the rest of the liquid outlet 23 comprises a hydrophobic surface fluidly connected to or in fluid communication with the peripheral rim 27.

It will be understood that liquid 105 according to the liquid image stamping arrangements of the present disclosure is firstly positioned at the exterior container surface 11 of the liquid container 10 whether by condensation collection or container liquid-letting action (e.g., liquid overflow or spillage). The liquid image stamping arrangements are further configured to secondly direct liquid 105 to form liquid imagery 12 from liquid deposition(s) 20 upon the support surface 102, which in some embodiments is beneath the liquid container 10 as supported by the drainage portion when the liquid container 10 is supported thereby. Referencing FIGS. 4 and 4A, the reader will there see the liquid imagery 12 having a predetermined, distinct, and recognizable outline in the form of simplified, one-eyed smiley face.

It will be recalled the liquid container 10 has longitudinal axis 100 and a radial axis 101 extending perpendicularly to the longitudinal axis 100. The longitudinal axis 100 is oriented vertically when the liquid container 10 is supported by the support surface 102. In some embodiments, the liquid image stamping arrangement according to the present disclosure has a drainage portion. Examples of the drainage portion include pathway 104 in fluid communication with the liquid inlet 18, tunnels 66, certain upper surfaces 25 of various embodiments, and certain exterior surfaces of all-in-one or combination embodiments. The drainage portions are configured to extend at least partially along the longitudinal axis 100 of the liquid container 10 so as to utilize at least one of the inherent properties of the liquid 105 to drain or direct the liquid 105 as firstly positioned on the exterior container surface 11 to a predetermined confluence zone 108.

The liquid image stamping arrangements according to the present disclosure further include a stamping portion. Examples of stamping portions include the peripheral rims 27 and bottom surfaces 56. The stamping portions are configured to extend at least partially along the radial axis 101 of the liquid container 10, and therebeneath in some embodiments so as to utilize at least one of the properties of the liquid 105 to direct the liquid 105 from the confluence zone 108 along the predetermined, distinct, and recognizable outline so as to form the liquid imagery 12 thereby. The stamping portion ay comprise a liquid attraction portion as at peripheral rims 27 and a liquid conveyance portion at the rim-to-surface interface 109. The liquid attraction portion is configured to attract liquid and allow the liquid to transfer from itself to the support surface 102 via the liquid conveyance portion. Distances from the support surface 102 will affect surface adhesion in some embodiments due to van der Waals forces in some embodiments.

It will thus be understood the drainage portion is configured to at least direct and/or shape the liquid 105 to form the liquid imagery 12. In some embodiments, the liquid image support surface 102 may be a select surface of the liquid container 10. For example, the liquid container 10 may be outfitted with specialized labeling having hydrophilic and hydrophobic portions to particularly attract or repel liquid as necessary where liquid imagery 12 may develop in a predetermined, distinct, and recognizable outline in some embodiments. In some embodiments, the liquid 105 is directed, at least in part, by surface energy interaction between liquid 105 and the various surfaces and surface configurations along which the liquid is directed.

The geometry or texture of configured surfaces with varying surface-to-liquid interactions, including hydrophilic and hydrophobic interactions, are operable to at least direct and/or shape said liquid 105 in some embodiments. Referencing FIG. 1, for example, the dry area 15 is a hydrophobic area while the openings 14 are hydrophilic in some embodiments. Hydrophilic regions are in fluid communication with one another, and in some embodiments, the fluid communication can be indirect, with very narrow gaps formed by hydrophobic surfaces, ridges, or channels as at channel 57 in FIG. 53. The drainage portion(s) are further in fluid communication with the hydrophilic structures to direct liquid to the stamping portion(s).

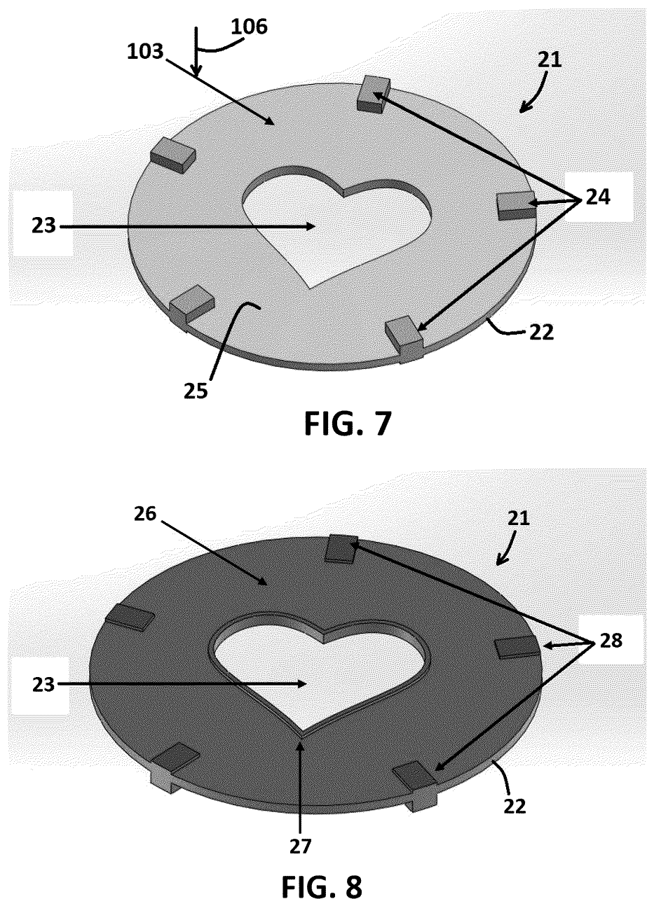

Referencing FIG. 7, the reader will there consider a further liquid image stamping arrangement or mechanism 21 according to the present disclosure. The liquid image stamping arrangement 21 comprises a main body 22, circular in form, with a particular diameter that approximates the diameter of a liquid container 10 usable therewith. The liquid image stamping arrangement 21 comprises a centralized liquid outlet 23 in the form of a heart shape. In some embodiments, the liquid outlets 23 according to the present disclosure are configured to shape liquid outletting therethrough for forming liquid imagery 12 and are further operable to provide the predetermined, distinct, and recognizable outline.

The liquid image stamping arrangement 21 further comprises a series of peripherally spaced container stabilizer elements 24 configured to stabilize the liquid container 10 relative thereto. The container stabilizer elements 24 extend upwardly from an upper surface 25 of the main body 22 configured to elevate the liquid container 10 relative to the liquid outlet 23 when supported by the container stabilizer elements 24. Downwardly directed 106 liquid 105 from the exterior container surface 11 is redirected as at 103 intermediate the container stabilizer elements 24 toward the liquid outlet 23. Notably, the number, size, shape, and location of the container stabilizer elements 24 may vary as dependent upon the particular application and the type of liquid container 10 implementation.

Referencing FIG. 8 depicting a bottom perspective view of the liquid image stamping arrangement 21, the heart-shaped liquid outlet 23 is located centrally relative to a bottom image support surface 26 thereof. The bottom image support surface 26 is a dry area of low surface adhesion comprising a hydrophobic material. A liquid outlet periphery is hydrophilic for attracting aqueous liquid thereto and in some embodiments and comprises a peripheral rim 27 of certain elevation relative to the bottom image support surface 26 to provide a higher surface adhesion of hydrophilic material to attract aqueous liquid thereto.

As introduced above, the peripheral rim elements 27 are of a height that is identical to the height of the surface stabilizer elements 28 in some embodiments, and of a height that is lesser than the height of the surface stabilizer elements 28 in some embodiments. Liquid at the liquid conveyance zone 108 or rim-to-surface interface 109 spontaneously moves to the support surface 102. In other words, the liquid image stamping arrangement 21 utilizes the hydrodynamic properties of the liquid 105 to direct the liquid 105 to the desired location. The height, size, shape, and location of the peripheral rim elements 27 are determined according to the required specifications of the application.

The liquid image stamping arrangement 21 further comprises a series of peripherally spaced surface stabilizer elements 28 that extend downwardly from the bottom image support surface 26 of the main body 22. The surface stabilizer elements 28 are configured to stabilize and/or elevate the liquid image stamping arrangement 21 as supported by the support surface 102. Both types of stabilizer elements 24 and 28 may be integrally formed with the main body 22 in certain embodiments. The size, shape, location, and number of areas for stabilization is determined according to the required needs. In some embodiments, the thickness of the stabilizer elements 28 is equal to the height of the peripheral rim 27. In this regard, the surface stabilizer elements 28 may be configured to cooperate with at least one peripheral rim 27 formed at the liquid outlet 23 to stabilize the peripheral rim 27 at the support surface 102 as in those embodiments where the height of the surface stabilizer elements 28 is equal to the height of the peripheral rim elements 27.

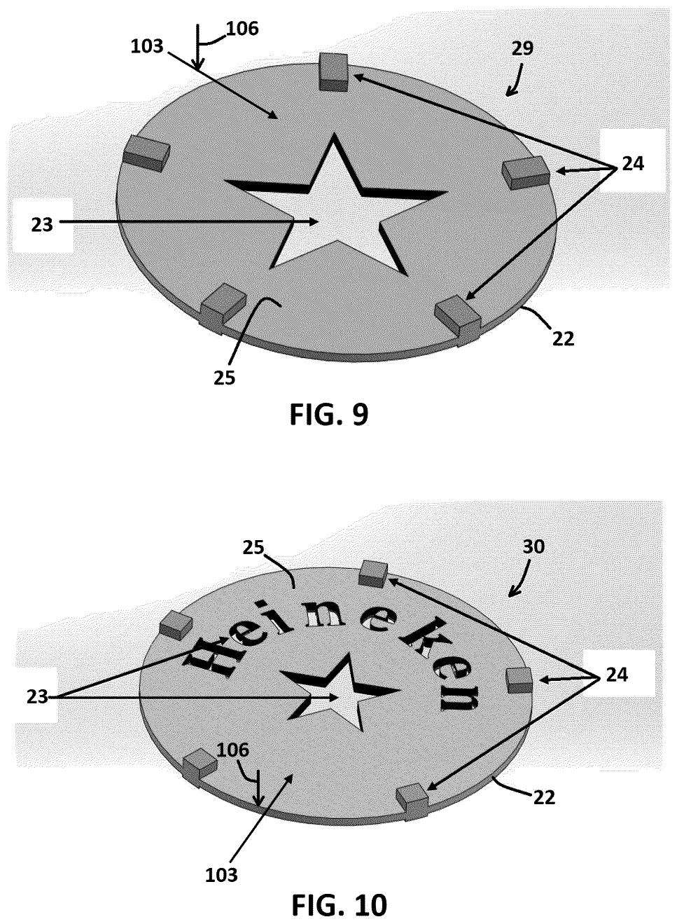

Referencing FIG. 9, the reader will there consider a further liquid image stamping arrangement or mechanism 29 according to the present disclosure substantially similar to liquid image stamping arrangement 21. The liquid image stamping arrangement 29 comprises a main body 22, circular in form with a particular diameter that approximates the diameter of a liquid container 10 usable therewith. The liquid image stamping arrangement 29 comprises a centralized liquid outlet 23 in the form of a star shape. The star-shaped liquid outlet 23 is operable to provide the predetermined, distinct, and recognizable outline.

The liquid image stamping arrangement 29 also comprises a series of peripherally spaced container stabilizer elements 24 extending upwardly from an upper surface 25 of the main body 22 configured to elevate the liquid container 10 relative to the liquid outlet 23 when supported by the container stabilizer elements 24. Downwardly directed 106 liquid 105 from the exterior container surface 11 is redirected as at 103 intermediate the container stabilizer elements 24 toward the liquid outlet 23. The number, size, shape, and location of the container stabilizer elements 24 may vary as dependent upon the particular application and liquid container 10.

Referencing FIG. 10, the reader will there consider a further liquid image stamping arrangement or mechanism 30 according to the present disclosure substantially similar to liquid image stamping arrangements 21 and 29. The liquid image stamping arrangement 30 comprises a main body 22, circular in form with a particular diameter that approximates the diameter of a liquid container 10 usable therewith. The liquid image stamping arrangement 30 comprises a centralized liquid outlet 23 in the form of a star shape in combination with a series of secondary liquid outlets 23 in the form of letters accurately arranged in radial adjacency to the centralized liquid outlet 23 to spell the mark/brand, “Heineken”. The mark/brand HEINKEN® is registered to Heineken Brouwerijen B.V. B.V. NETHERLANDS with business address of Tweede Weteringplantsoen 21 Amsterdam, Netherlands, NL1017 ZD. As earlier introduced, in some embodiments, the liquid image stamping arrangements according to the present disclosure deposit liquid 105 to form liquid imagery 12 in the form of an advertising logo in certain embodiments.

The liquid outlets 23 are operable to provide predetermined, distinct, and recognizable outlines for supporting liquid depositions 20 to provide branded liquid imagery 12. The liquid image stamping arrangement 30 also comprises a series of peripherally spaced container stabilizer elements 24 extending upwardly from an upper surface 25 of the main body 22 configured to elevate the liquid container 10 relative to the liquid outlets 23 when supported by the container stabilizer elements 24. Downwardly directed 106 liquid 105 from the exterior container surface 11 is redirected as at 103 intermediate the container stabilizer elements 24 toward the liquid outlets 23. Referencing FIG. 11 the reader will there consider a bottom perspective view of the liquid image stamping arrangement 30. In particular, the reader is directed to peripheral rims 27 extending downwardly from each of the liquid outlets 23, preferably formed of a hydrophilic material to draw or attract aqueous liquids thereto for better forming the liquid imagery 12. Surface stabilizer elements 28 help stabilize the drainage portion 30 when supported by the support surface 102 and are configured to cooperate with the peripheral rims 27 for stabilization in this embodiment.

Referring now to FIG. 12, the reader is directed to a liquid image stamping arrangement 31 showing a bow tie shaped logo commonly known to be a source indicator for the BUDWEISER® brand of Anheuser-Busch, LLC at One Busch Place, St. Louis, Missouri, 63118. The liquid image stamping arrangement 31 provides a distinctive “floating” image-defining element 32 configured to cooperate with a liquid-shaping outlet for providing liquid imagery 12 having a defined thickness upon the support surface 102. More particularly, the image-defining element 32 is connected to the main body 22 via a series of bridge elements 33 with a channel type liquid outlet 34 or liquid-letting channel extending between an inner periphery 36 and an outer periphery 37 of a liquid-letting channel 34 surrounding the image-defining element 32. In some embodiments, the bridge elements 33 are configured above the support plane 107 when the arrangement along with the container 10 is placed on the image support surface 102. In some embodiments, the bride elements 33 have a length of no more than 10 mm, particularly, 5 mm, and yet more particularly 2 mm.

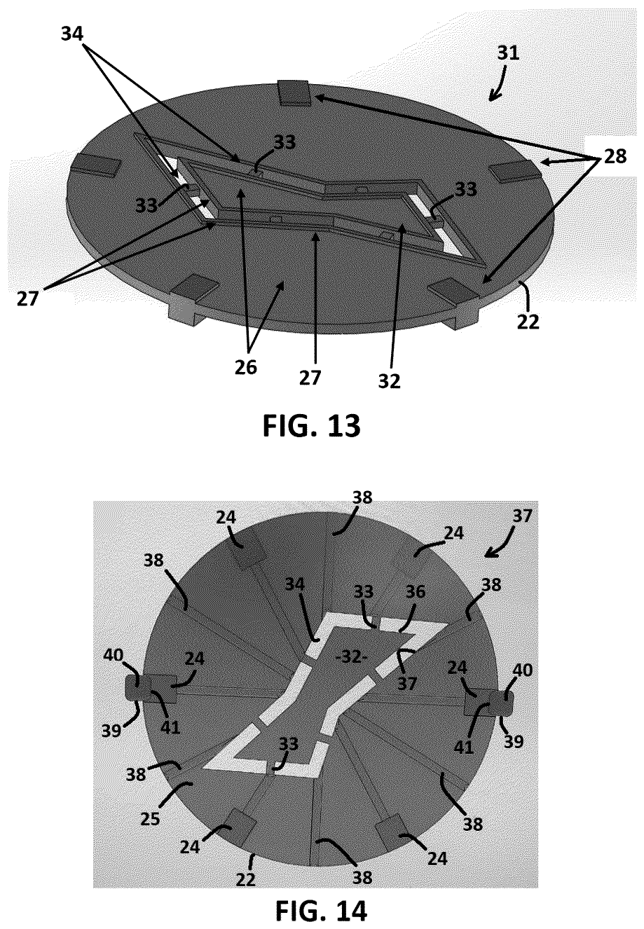

The image-defining element 32 comprises a hydrophilic element periphery for attracting aqueous liquid thereto in some embodiments. The bridge elements 33 hold the image-defining element 32 at the desired location while not influencing liquid flow and are configured so as to avoid contact with the liquid imagery 12 in certain embodiments. In this regard, the reader will note the bridge elements 33 are recessed relative to the peripheral rims 27 thereby enabling liquid deposition 20 without structural interference therefrom. In certain other embodiments, the bridge elements 33 may direct liquid to the liquid-letting channel 34. The number, size, shape, and location of the bridge elements 33 are determined by the application. Referencing FIG. 13 the reader will there consider a bottom perspective view of the liquid image stamping arrangement 31. In particular, the reader is directed to peripheral rims 27 extending downwardly from each of the liquid outlets 23, preferably formed of a hydrophilic material to draw or attract aqueous liquids thereto for better forming the liquid imagery 12. Surface stabilizer elements 28 help stabilize the drainage portion 30 when supported by the support surface 102 and are configured to cooperate with the peripheral rims 27 for stabilization.

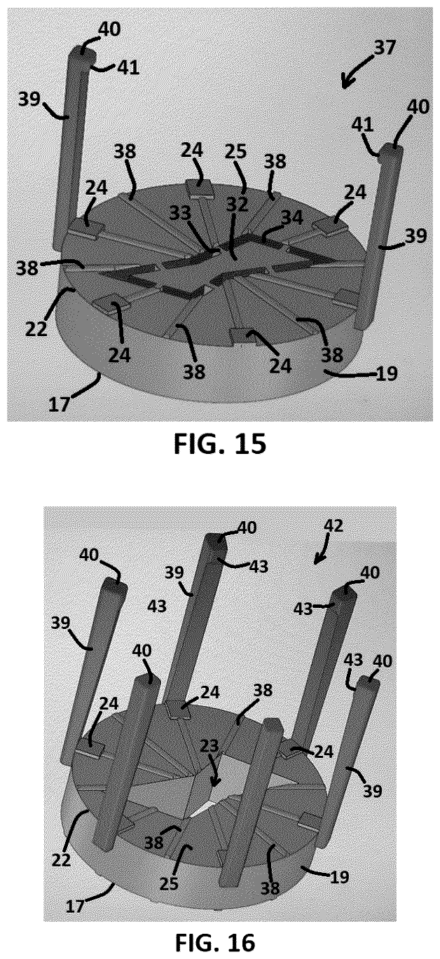

Comparatively referencing FIGS. 14 and 15, the reader will there consider a further liquid image stamping arrangement 37. The liquid image stamping arrangement 37 comprises an upper surface 25, a lower end 17, and a raised stabilizer element 19. At the center of the upper surface 25 is a liquid-letting channel 34 surrounding an image-defining element 32 connected to the main body 22 by a series of bridge elements 33. A series of liquid-directing ridges 38 are radially directed towards the image-defining element 32 from the stabilizer element 19 for channeling liquid 105 toward the liquid-letting channel 34. In some embodiments, the upper surface 25 may also slope toward the liquid outlet as exemplified by the liquid-letting channel 34 in this embodiment. In some embodiments, liquid image stamping arrangement 37 can be integrally formed with a liquid container with a double bottom or provided as an add-on attachment to a liquid container 10.

The reader will further note the series of raised container stabilizer elements 24 peripherally spaced about the circumference of the circular main body 22. At laterally opposed sides of the main body 22 are upwardly extending container stabilizer arm elements 39, optionally integrally formed with select container stabilizer elements 24. The stabilizer arms 39 need not be structurally connected to or otherwise aligned with the container stabilizer elements 24 in some embodiments. However, in this embodiment, the container stabilizer elements 24 are aligned with the container stabilizer arms 39 configured to extend upwardly from the main body 22 for engaging and stabilizing the liquid container 10. The stabilizer arm elements 39 comprise upper arm ends as at 40, which may be configured to provide surfacing to either better mate with an exterior container surface 11 of a liquid container 10 or removably attach thereto.

In other words, the upper arm ends 40 may comprise a container-opposing surfaces configured to mimic the contour of the exterior container surface 11 of the liquid container 10 for enhancing stability of the liquid container 10 when engaged with the various liquid image stamping arrangement(s). As depicted in FIG. 15, the upper arm ends 40 comprise rim-engaging projections as at 41, which may operate to engage an upper rim of a liquid container 10. Accordingly, in some embodiments, the upper stabilizer ends 40 are configured to removably attach the liquid image stamping arrangements to the liquid container 10.

The upwardly extending stabilizer arm elements 39 may be formed from a resilient material in some embodiments. In these embodiments, the stabilizer arm elements 39 are resiliently actuable to resiliently engage and stabilize a liquid container 10 received atop the container stabilizer elements 24, which also elevate the liquid container 10 relative to the liquid outlet(s) 23. In some embodiments, the stabilizer elements 24 must elevate the bottom of the liquid container 10 to achieve drainage. In some embodiments, the stabilizer arm elements 39 may be hydrophilic for attracting liquid 108 and directing the liquid 105 to the conveyance zone 108, and need not extend to a container rim to do so.

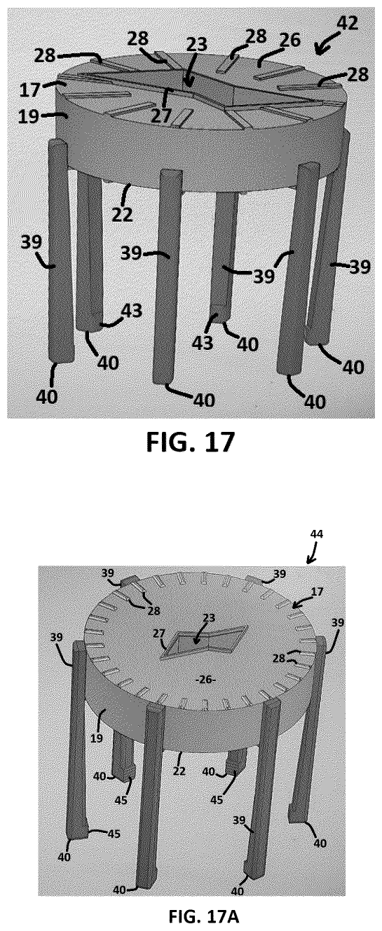

Comparatively referencing FIGS. 16 and 17, the reader will there consider a further liquid image stamping arrangement 42 according to the present disclosure. The liquid image stamping arrangement 42 comprises an upper surface 25, a lower end 17, and a stabilizer element 19. At the center of the main body 22 and extending downwardly from the upper surface 25 is a liquid outlet 23. A series of liquid-directing ridges 38 are radially directed towards the liquid outlet 23 from a raised stabilizer element 19 for channeling liquid 105 toward the liquid outlet 23. In some embodiments, the upper surface 25 may also slope toward the liquid outlet 23. A series of raised container stabilizer/elevating elements 24 are peripherally spaced about the circumference of the circular main body 22.

Each stabilizer element 24 may be aligned with an upwardly extending stabilizer arm element 39, optionally integrally formed with the container stabilizer elements 24. As noted above, the stabilizer arm elements 39 need not be aligned with the stabilizer elements 24 in some embodiments. The stabilizer arm elements 39 comprise upper arm ends as at 40, which may be configured to provide container-opposing surfaces 43 configured to engage an exterior container surface 11 of a liquid container 10. FIG. 17 is a bottom perspective view of the liquid image stamping arrangement 42 showing a series of downwardly extending stabilizer elements 28 and a peripheral rim 27 surrounding the liquid outlet 23.

Referencing FIG. 17A, the reader will there consider a further liquid image stamping arrangement 44 according to the present disclosure. Similar to the liquid image stamping arrangement 42, the liquid image stamping arrangement 44 comprises a series of downwardly extending stabilizer elements 28 radially directed to the center located liquid outlet 23 with peripheral rim 27. A series of upwardly extending stabilizer arms 39 are peripherally spaced about the raised stabilizer element 19 as attached to the main body 22. The stabilizer arm elements 39 comprise upper arm ends 40, which may be configured to provide ridged surfaces 45 operable to grip an exterior container surface 11 of a liquid container 10.

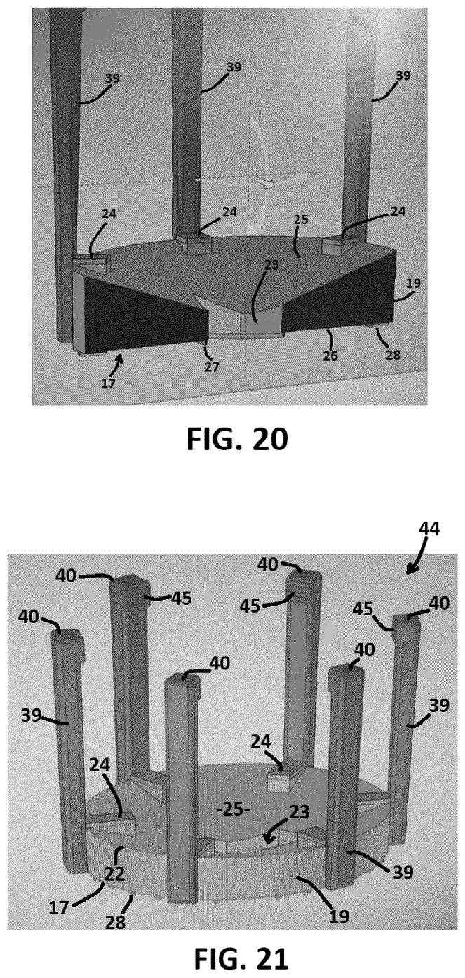

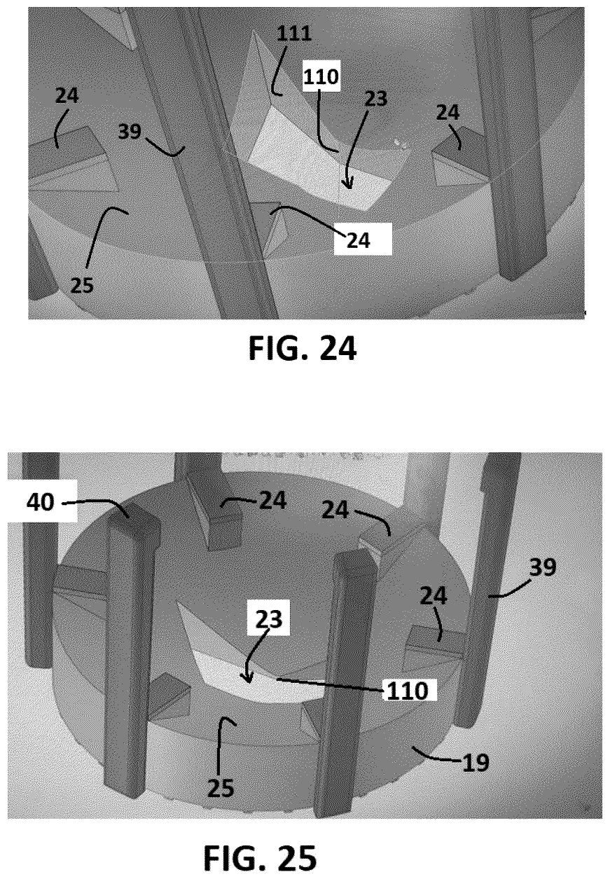

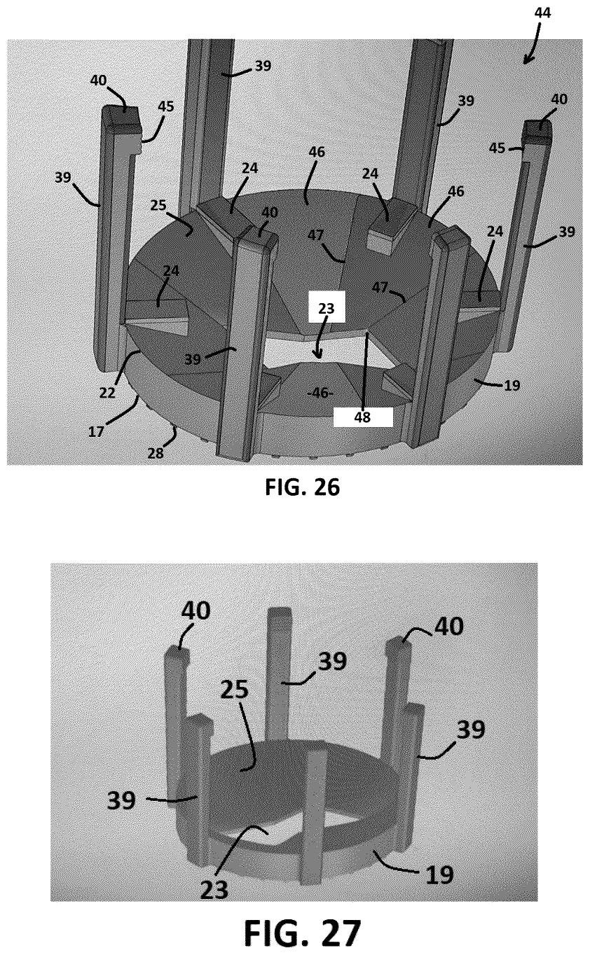

In other words, the ridged surfaces 45 are configured to help grip the exterior container surface 11 of the liquid container 10 for enhancing stability of the liquid container 10 when engaged with the liquid image stamping arrangement(s) in some embodiments. The upper surface 25 is smoothly sloped in some embodiments toward the centralized liquid outlet 23 as more clearly depicted in the sectional views presented in FIGS. 19 and 20. FIGS. 24 and 26 show an alternative upper surface 25 with sloped panel portions 46 with lines of demarcation 47 therebetween for directing liquid flow toward the liquid outlet 23 formed at a reduced thickness 48 as compared to the thickness 49 of the raised stabilizer element 19. Comparatively referencing different embodiments, the reader will see differing angles of inclination of the sloped upper surfaces 25. Different slopes direct the liquid differently and to different locations. The facet 110 is also determined by a given slope. The facet 110 can be in different heights in different locations or it can be at the same height all over the logo. Different heights of facet 110 determine the speed at which liquid will convey to the stamping portion.

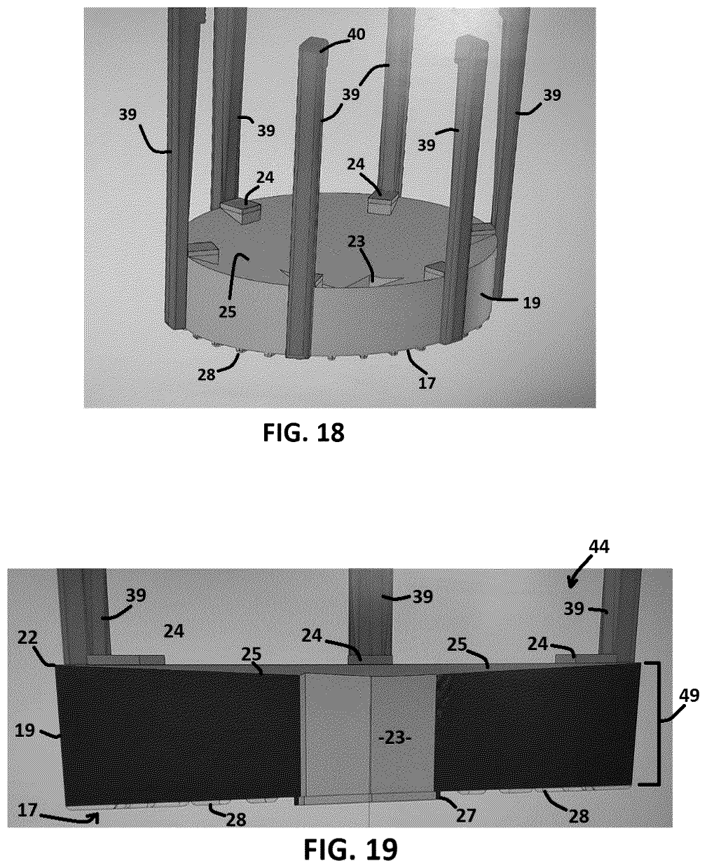

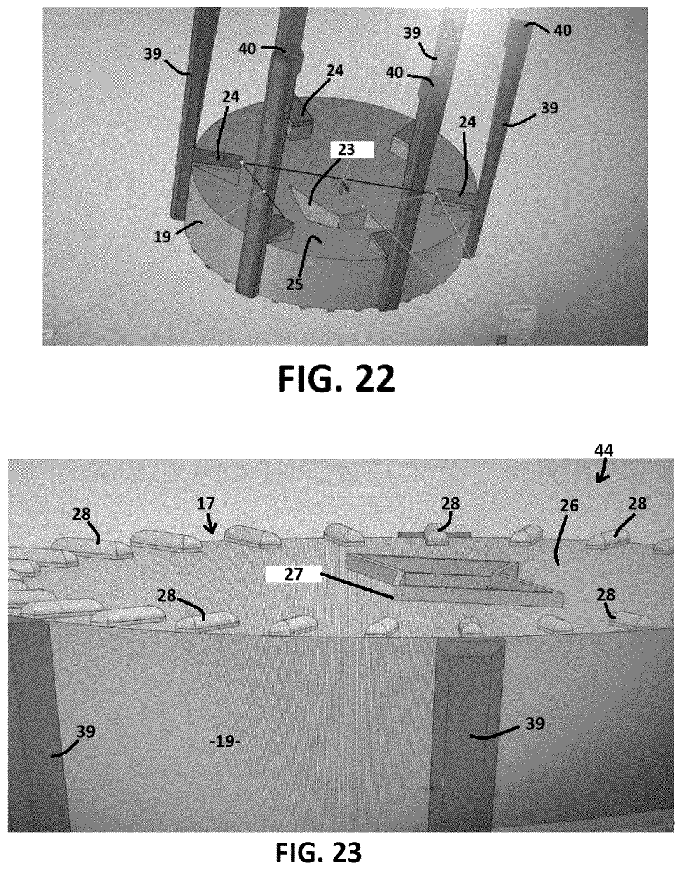

FIGS. 18 through 22 and FIGS. 24 through 27 depict various liquid image stamping arrangements, including liquid image stamping arrangement 44. The reader will consider the upper surfaces 25 of these arrangements noting that the upper surfaces 25 may comprise variously inclined or sloped surfacing with facets 110 of varied dimensions at the liquid outlets 23. Sloped upper surfaces 25 of relatively greater inclination may be incorporated into the various liquid stamping arrangements to quicken liquid delivery to the liquid outlets 23 and stamping portions as may be important in low humidity environments wherein condensation formation and collection is generally slower.

FIGS. 18, 21, and 22, in particular, show a liquid image stamping arrangement having a relatively smooth upper surface 25 of generally concave configuration with a centered liquid outlet 23 with container stabilizer elements 24 positioned about the periphery to elevate a liquid container 10 relative to the centered liquid outlet 23. This embodiment may be useful where condensate collection about the periphery of a liquid container 10 is relatively uniformly directed downwardly into the drainage portion defined, in part, by the upper surface 25. FIGS. 24 and 25 comparatively show liquid image stamping arrangements wherein the facet 110 of the arrangement shown in FIG. 24 is of greater height than the facet 110 shown in FIG. 25. The facet 110 is also determined by a given slope of the upper surface 25. The facets 110 can be in different heights in different locations or it can be at the same height along the periphery 111 of the liquid outlet 23. Differing heights of facets 110 determine the speed at which liquid 105 will convey to the stamping portion.

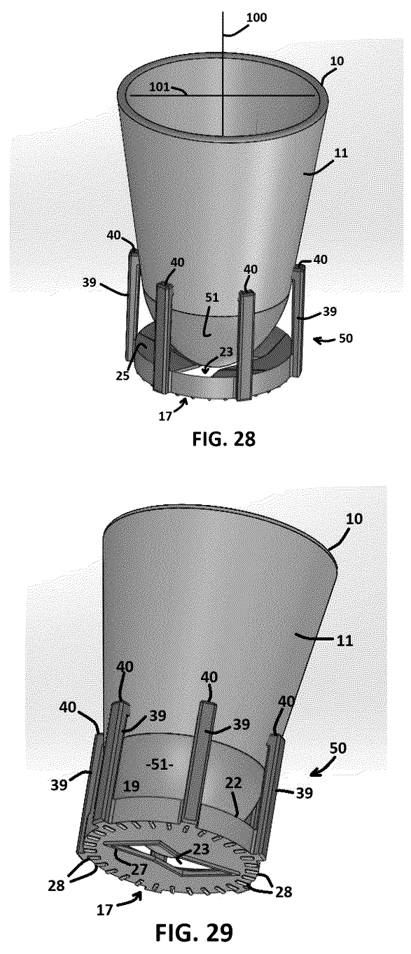

FIGS. 28 through 31 depict a further hybrid type liquid image stamping arrangement 50 according to the presently disclosed subject matter that is an alternative combination liquid image stamping arrangement. Liquid image stamping arrangement 50 is integrally formed with the liquid container 10 in this embodiment with a closed and rounded lower bottom portion 51. Liquid 105 is directed to the liquid outlet 23 primarily by means of drainage from the exterior container surface 11 to the upper surface 25 of the liquid image stamping arrangement 50. In this embodiment, the liquid imagery 12 formed is by way of the liquid collection at the liquid outlet 23 optionally outfitted with a peripheral rim 27 at the bottom image surface 26 in adjacency to the liquid outlet 23, which as earlier introduced may further comprise hydrophilic properties to attract or hold liquid at the outlet 23 for forming the liquid imagery 12.

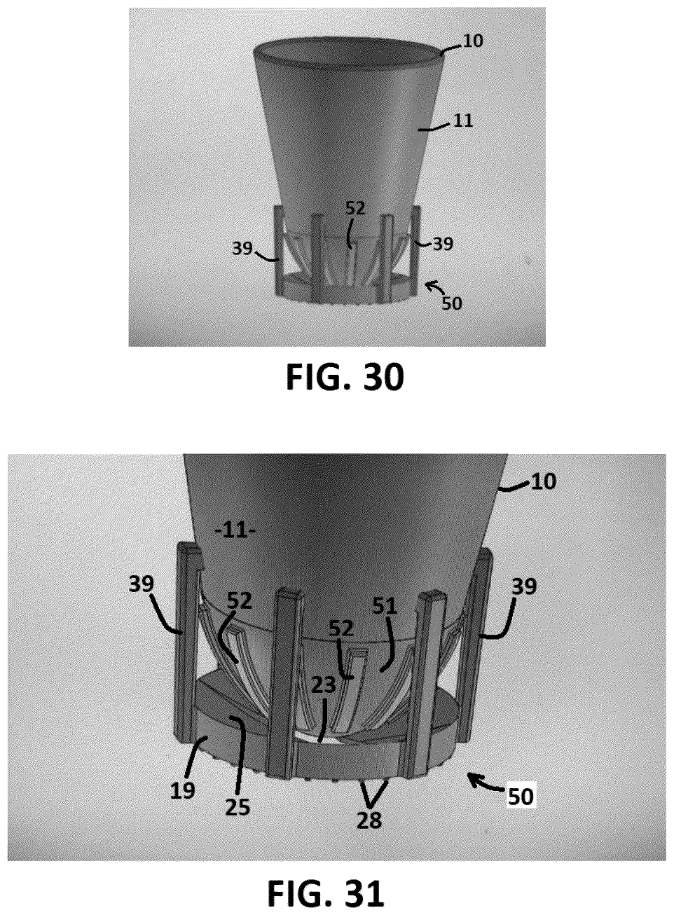

The reader will note the omission of raised container stabilizer elements 24 in this embodiment. The liquid image stamping arrangement 50 is particularly configured to support an integrally formed open top liquid container 10 with rounded bottom portion 51 particularly configured to mate with the liquid image stamping arrangement 50 and thereby provides a combination liquid image stamping arrangement. The exterior container surface 11 directs liquid 105 toward the liquid outlet 23 in sloped relation relative to the upper surface 25 of the liquid image stamping arrangement 50. The liquid drains from area 51 and is directed to the desired location by the contoured exterior surfacing. The shape and material construction of the upper end(s) 40 an the stabilizer arms 39 also determine directed liquid flow in some embodiments. In some embodiments, the rounded bottom portion 51 of the liquid container comprise ridge elements 52 for channeling or directing liquid 105 toward the liquid outlet 23 as generally depicted in FIGS. 30 and 31.

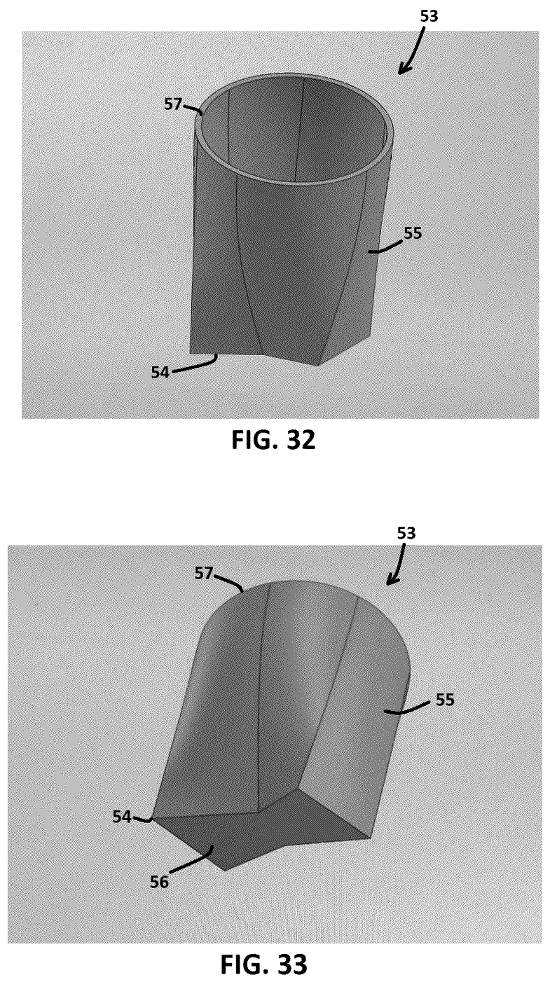

FIGS. 32 and 33 generally depict a first all-in-one or combination liquid image stamping arrangement 53 according to the present disclosure. All combination liquid image stamping arrangements according to the present disclosure direct liquid from an outward location inwardly toward the bottom end 54. In the illustrated embodiment, the bottom end 54 of the liquid image stamping arrangement 53 is configured to resemble the bow tie-shaped BUDWEISER logo earlier introduced. The exterior container surface 55 of the liquid image stamping arrangement 53 is generally smooth and sloped from the circular upper end 57 to the bow tie shaped bottom end 54. The bottom surface 56 comprises at least a portion of hydrophilic material in certain embodiments so as to draw aqueous liquid 105 thereto for forming the liquid imagery 12 upon the support surface 102. Further, the surface contours direct liquid inwardly. In some embodiments, the bottom surface 56 is configured to comprise a channel 57 or a hole or a ridge, etc. for demarcating an inner liquid image 58 and an outer border liquid image 59 for accentuating the overall liquid imagery 12. In this regard, the reader is directed to comparatively reference FIGS. 53 and 54.

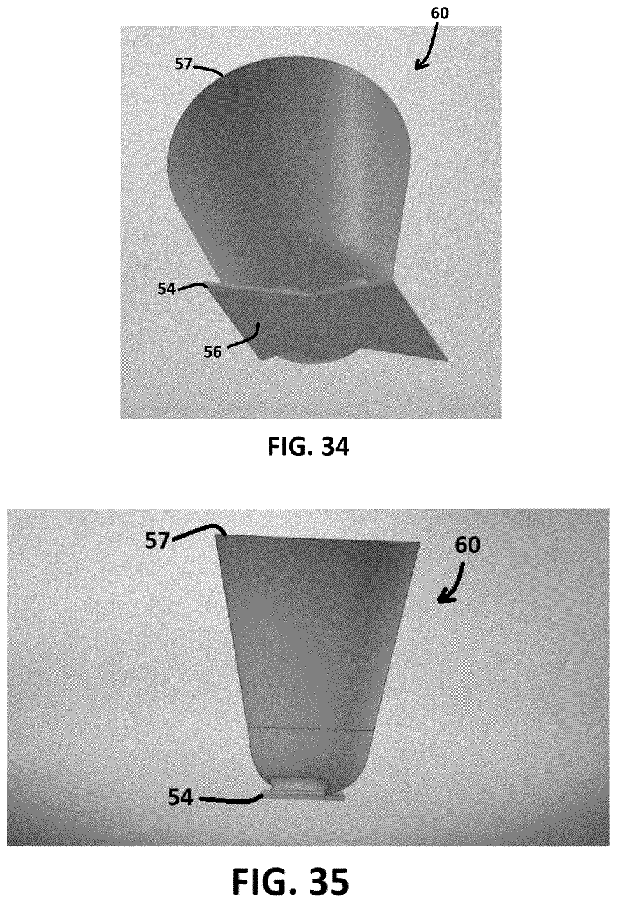

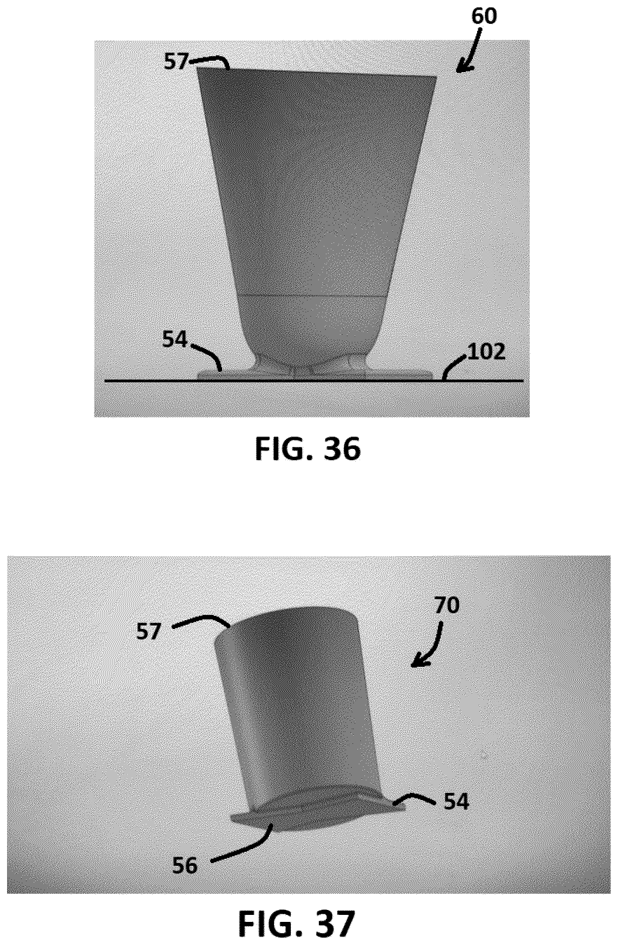

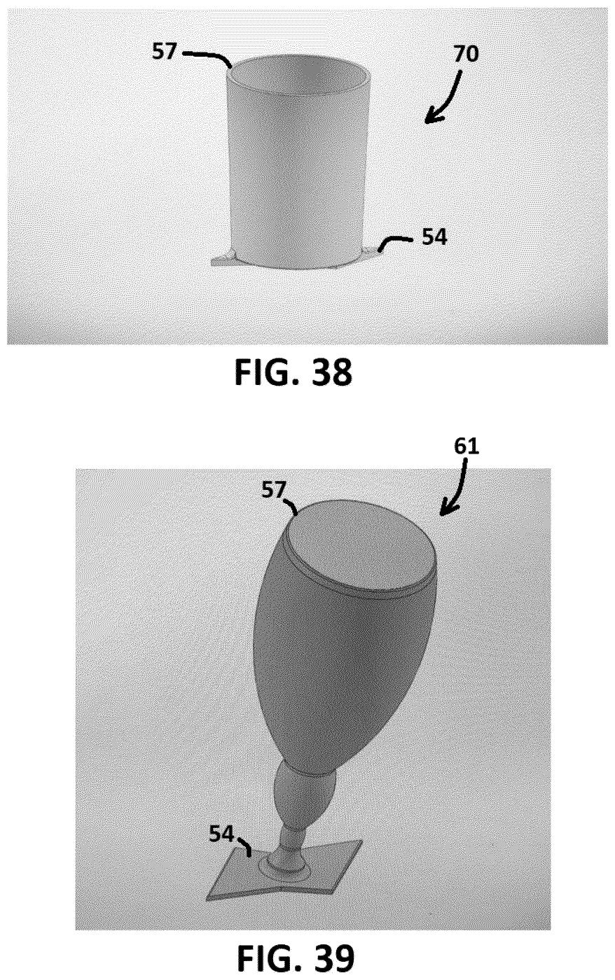

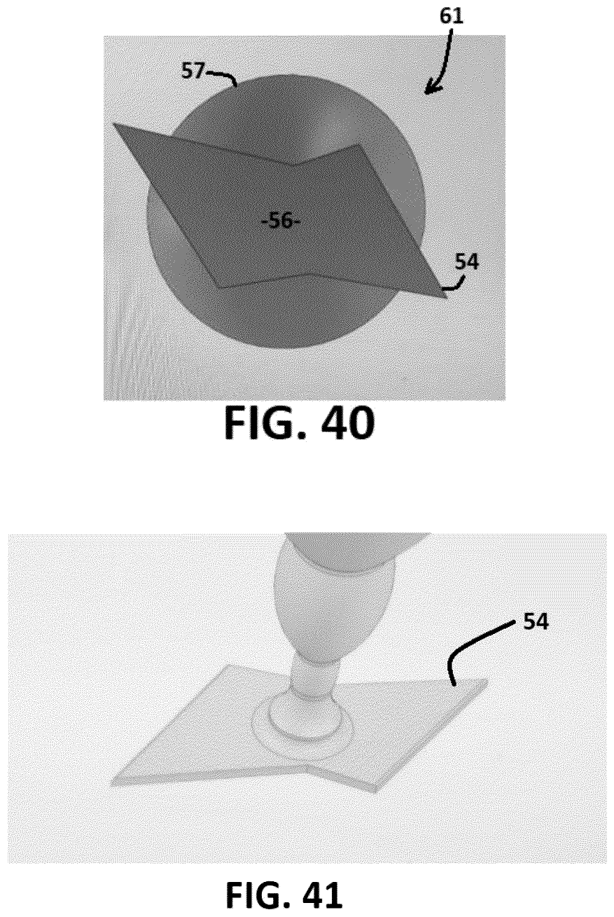

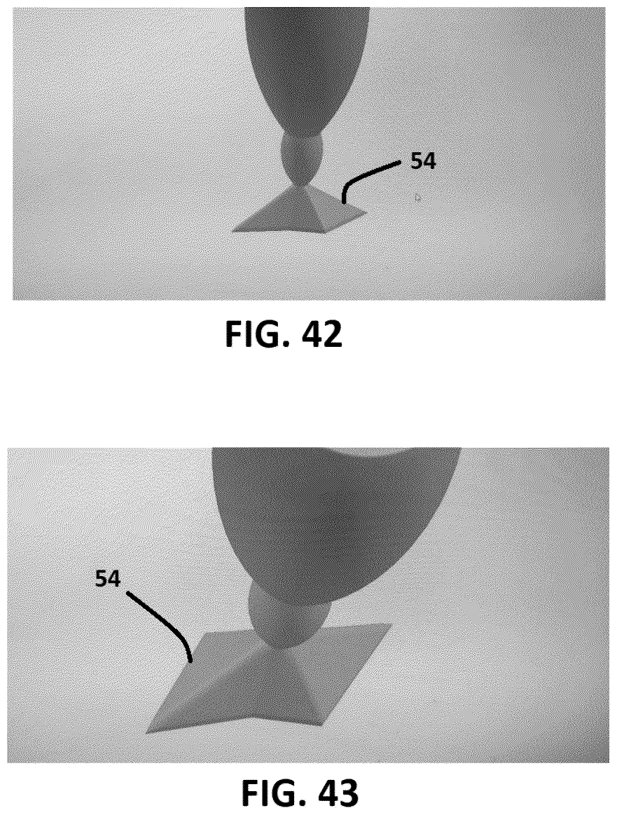

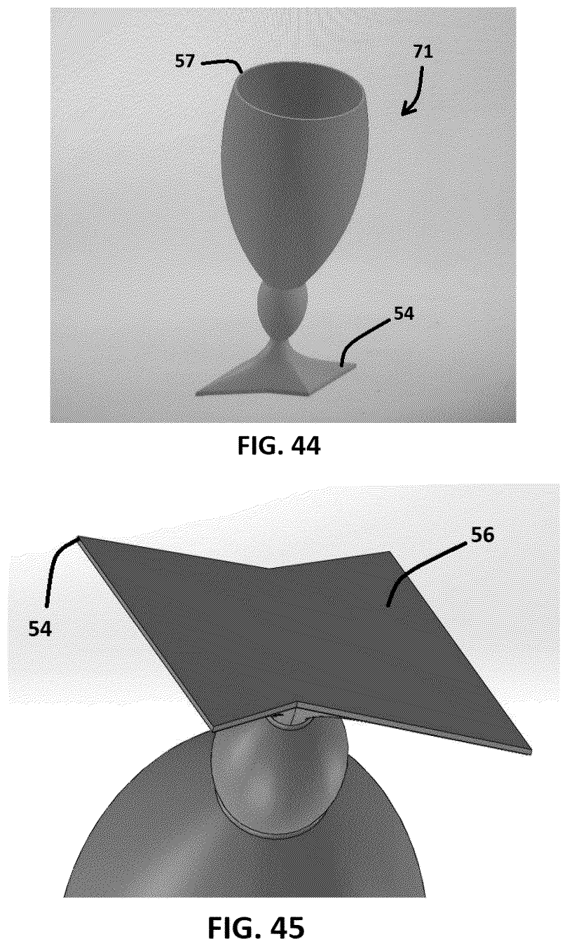

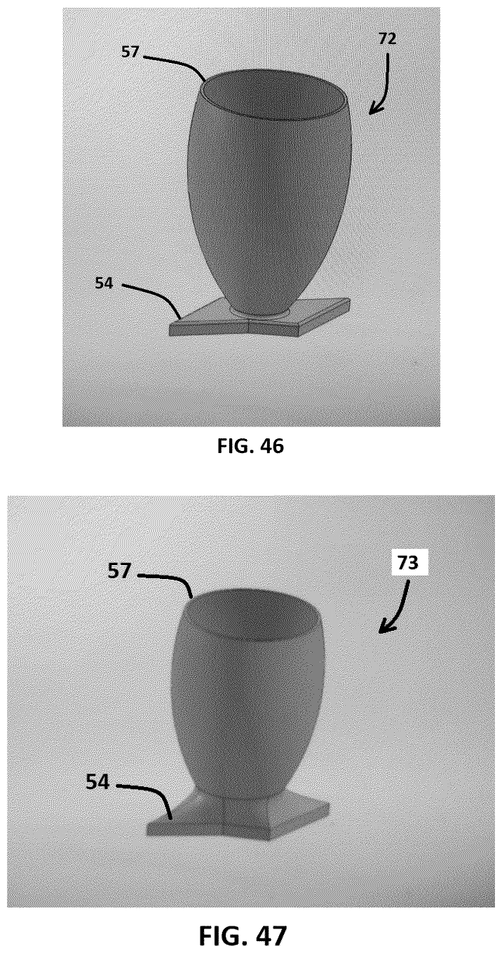

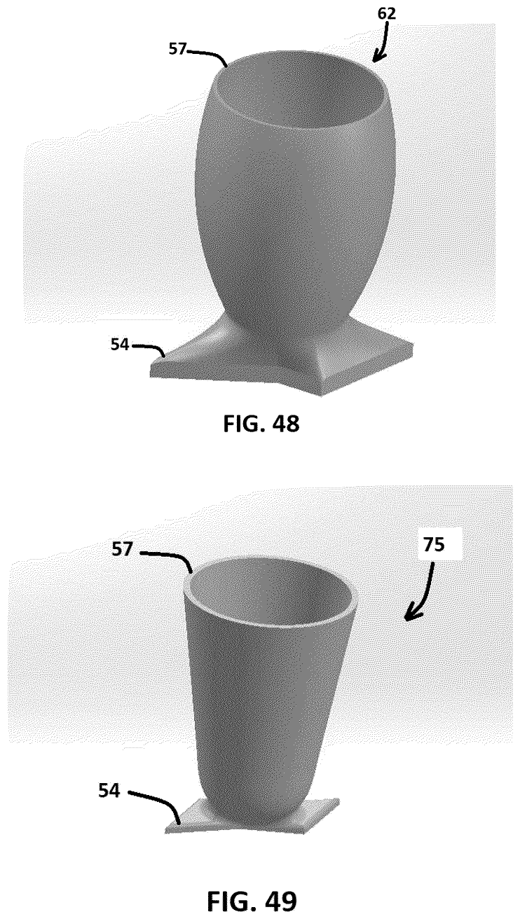

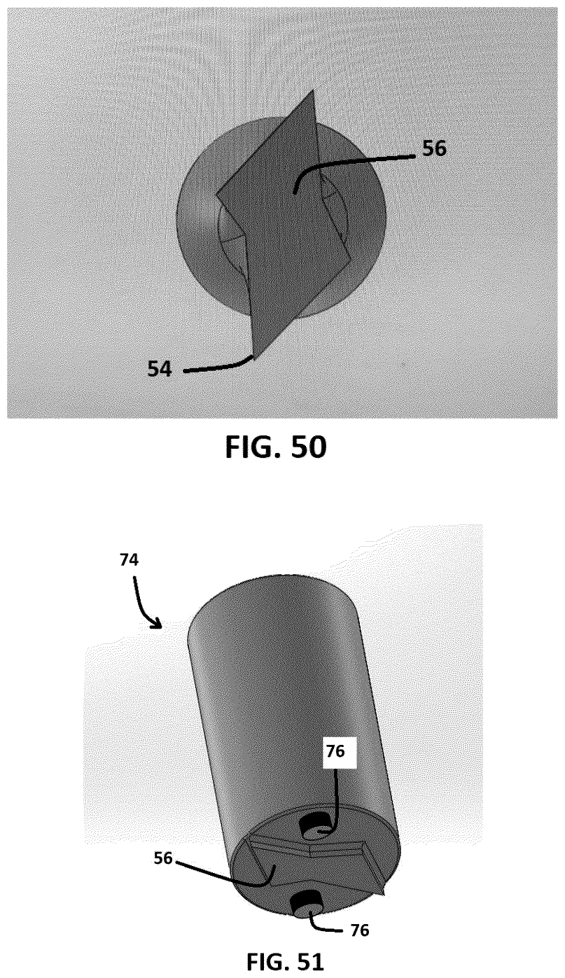

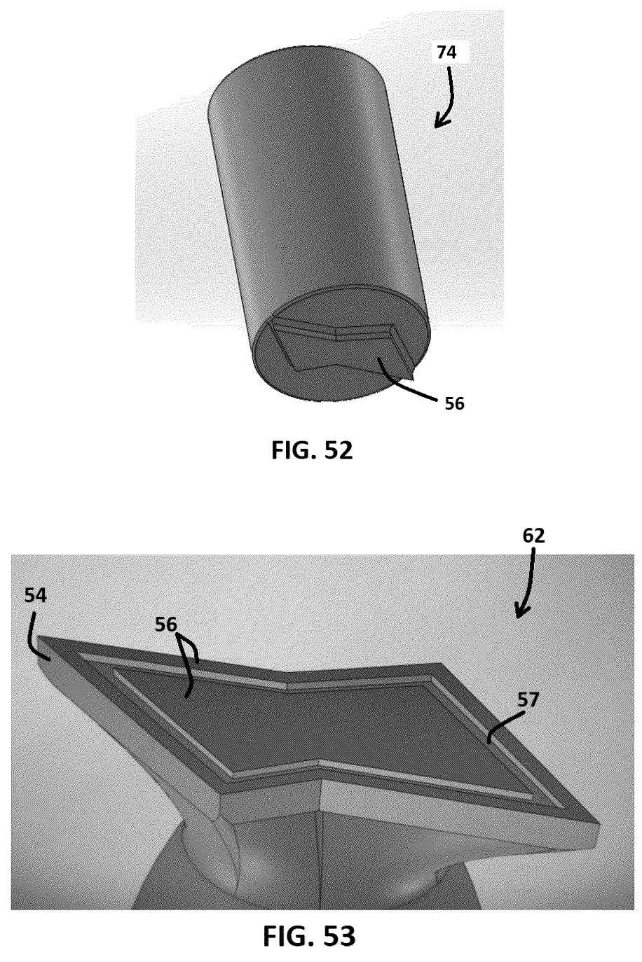

FIGS. 34 through 53 generally depict a series of alternative all-in-one or combination liquid image stamping arrangements as at 60, 61, 62, 70, 71, 72, 73, 74, and 75 according to the present disclosure. The liquid image stamping arrangements 53, 60, 61, 62, 70, 71, 72, 73, 74, and 75 all depict bow tie-shaped BUDWEISERR logo shaped bottom ends 54 and an exterior container surface that generally slopes toward the bottom ends 54. As with liquid image stamping arrangement 53, the bottom surfaces 56 comprise at least a portion of hydrophilic material in certain embodiments so as to draw aqueous liquid 105 thereto for forming the liquid imagery 12 upon the support surface 102. In some embodiments, the stamping portion is flat as generally depicted and referenced at surface(s) 56. In some embodiments, the bottom surfaces 56 are configured to provide a channel 57 for demarcating an inner liquid image 58 and an outer border liquid image 59 separated by a dry region 63 therebetween for accentuating the overall liquid imagery 12 upon the support surface 102 as generally depicted in FIG. 54. In some embodiments, a hydrophobic material may be applied to the bottom surface 56 to repel liquid 105 to form the dry region 63 as an alternative to the channel 57.

It will be understood that the presently disclosed subject matter further supports a process for stamping liquid imagery 12 upon an image support surface 102 comprising a series of steps. It will be recalled, for example, that the liquid container 10 is configured to hold a liquid having both cohesive and adhesive properties, which liquid container 10 has a longitudinal axis as at 100 and a radial axis as at 101 that extends perpendicularly to the longitudinal axis 100. The liquid container 10 is supported by a support surface 102 such that the longitudinal axis 100 extends vertically and the radial axis 101 extends horizontally. A liquid portion either in the form of condensate or liquid overflow/spillage is first positioned at the exterior container surface 11 of the liquid container 10 adjacent a drainage portion configured to extend at least partially along the longitudinal axis 100 so as to utilize at least one of the cohesive and adhesive properties to drain the liquid 105 firstly positioned on the exterior container surface 11 toward a predetermined confluence zone generally located downwardly relative to the liquid container 10. The liquid 105 positioned at the exterior container surface 11 is then directed along the exterior container surface 11 toward along a stamping portion configured to extend at least partially along the radial axis 101 so as to utilize at least one of the cohesive and adhesive properties to form liquid imagery 12 upon the support surface 102, which imagery 102 comprises a predetermined, distinct, and recognizable outline.

The reader will note that directing liquid by way of the stamping/drainage portions according to the present disclosure is dependent upon surface energy levels and the cohesive and adhesive characteristics of the liquid typically involving aqueous solutions. The dimensions of liquid-directing guideways are essentially dictated by droplet size, surface tension of the liquid, and the surface energy levels. A water droplet will typically have a diameter of between 0.1 micrometer to approximately 6-7 millimeters. An increase in droplet diameter corresponds to a dramatic increase the droplet weight and structural and material adjustments may be required depending on the application.

Liquid adhesion to surfaces is dependent upon the material construction of the surfaces which, as described, can be plastic, glass, metallic, etc. It should also be recalled the materials may have varying degrees of smoothness/roughness and porosity. Notably, state-of-the art liquid containers are typically symmetric and/or continuous for stability. The presently disclosed subject matter can be implemented regardless of symmetry or continuity due to the incorporation of stability points and bridge elements as necessary. Accordingly, in some embodiments, the stamping portion is non-continuous, comprising at least one gap between two adjacent non-continuous portions thereof, which gaps may have a width being no greater than 10 mm, particularly, 5 mm, and yet more particularly, 2 mm to cooperate with naturally occurring droplet size due to surface tension as affected by material construction of opposed surfacing in some embodiments. In some embodiments, for example, the gap may comprise a hydrophobic surface.

In general, the LIQUIAD image stamping arrangement and method according to the presently disclosed subject matter can be essentially described as an advertising medium. The present disclosure is operable to produce all kinds of logos and images by way of liquid deposition 20 as derived from liquid 105 drifting down a liquid container 10 thereby depositing a liquid image 12 on the support surface 102 such as a tabletop 65 after removing the liquid container 10 from the support surface 102. The shape of each predetermined, distinct, and recognizable outline is dependent on the specific application for the desired imagery. The examples presented above are meant to be exemplary and non-limiting. Other combinations and iterations are possible, including any number of different logos/figures, and any number of different liquid containers including kitchenware, glass, bottles, cans, etc. It is foreseen that additional research including selection, and testing of the various parameters for implementations of the current embodiment are possible. Based on the above description, one skilled in the art will be able to select the quantity, shape, and materials for a specific application.

What is claimed is:

1. A liquid image stamping arrangement for a container, said container being configured to hold a substance while being placed upon a support surface,
whereby said arrangement, liquid having cohesive and adhesive properties firstly positioned at an exterior container surface of said container is configured to be secondly directed through utilization of its cohesive and adhesive properties by said arrangement to form an imagery from said liquid on the support surface, beneath said container, when the container is placed thereupon, said imagery comprising a predetermined, distinct, and recognizable outline.

2. The liquid image stamping arrangement according to claim 1, wherein said container has a longitudinal axis oriented vertically when the container is uprightly placed on the support surface, and a radial axis extending perpendicularly to said longitudinal axis; and wherein said liquid image stamping arrangement comprises:
a drainage portion configured to extend at least partially along said longitudinal axis of the container so as to utilize at least one of said properties to drain the liquid positioned on the exterior container surface to at least one predetermined confluence zone; and
a stamping portion having a shape corresponding to the distinct and recognizable outline, configured to extend at least partially along the radial axis of the container, and therebeneath, so as to utilize at least one of the properties of the liquid to direct said liquid from the confluence zone along said outline, so as to form said imagery thereby.

3. The liquid image stamping arrangement according to claim 2, wherein said arrangement comprises a bottom image support surface, configured to be placed directly beneath said container, facing said support surface on which said arrangement is placed.

4. The liquid image stamping arrangement according to claim 3, wherein said confluence zone spans, at least in part, along said bottom image support surface.

5. The liquid image stamping arrangement according to any one of claims 2 through 4, wherein said drainage portion comprises hydrophobic surfaces while said stamping portion comprises hydrophilic surfaces.

6. The liquid image stamping arrangement according to any one of claims 3 through 5, when depending on claim 3, wherein the stamping portion protrudes from the bottom image support surface.

7. The liquid image stamping arrangement according to any one of claims 2 to 6, wherein said arrangement comprises at least one stabilizer element configured to stabilize said arrangement along with said container when they are placed on the support surface, said stabilizer element defining a support plane adjacent the support surface, on which said container along with said arrangement is configured to rest, wherein, when the arrangement along with the container are placed on the support surface, said stamping portion is disposed at a height with respect to the support plane being identical to the support plane or slightly above it, so as to allow liquid applied on the stamping portion to spontaneously pass through the support plane to the support surface, when the arrangement is placed on the support surface.

8. The liquid image stamping arrangement according to claim 7, wherein said stabilizer element constitutes a part of said stamping portion.

9. The liquid image stamping arrangement according to any one of claims 6 through 8, wherein said stabilizer element protrudes from the bottom image support surface.

10. The liquid image stamping arrangement according to any one of claims 2 through 9, wherein said stamping portion is asymmetric.

11. The liquid image stamping arrangement according to any one of claims 2 through 10, wherein said drainage portion comprises tunnels extending from the at least one confluence zone.

12. The liquid image stamping arrangement according to any one of claims 2 through 11, wherein said outline is asymmetric.

13. The liquid image stamping arrangement according to any one of claims 2 through 12, wherein said stamping portion is non-continuous.

14. The liquid image stamping arrangement according to claim 13, wherein said stamping portion comprises at least one gap between two adjacent non-continuous portions thereof, said gap having a width being no greater than 10 mm, particularly, 5 mm, and yet more particularly, 2 mm.

15. The liquid image stamping arrangement according to claim 14, wherein said gap comprises a hydrophobic surface.

16. The liquid stamping arrangement according to any one of claims 2 to 15, wherein said stamping portion is flat.

17. The liquid stamping arrangement according to any one of claims 2 to 15, wherein said stamping portion comprises at least one rim having a shape corresponding to at least a portion of said outline.

18. The liquid image stamping arrangement according to any one of claims 2 to 17, wherein the drainage portion comprises a liquid outlet having a shape corresponding to said outline, so as to shape liquid outletting therethrough for forming said imagery, said outlet being constituted by a through opening in a surface of the arrangement.

19. The liquid image stamping arrangement according to claim 18, when dependent on claim 7, wherein the at least one stabilizer element is configured to at least partially surround said liquid outlet.

20. The liquid image stamping arrangement according to claim 19, wherein said stabilizer element is configured to elevate said container relative to the liquid outlet at a container support plane parallel to the support surface.

21. The liquid image stamping arrangement according to any one of claims 18 through 20, wherein said outlet comprises at least one peripheral rim configured to face said support surface when the arrangement along with the container is placed thereon, said peripheral rim constituting at least a part of said stamping portion.

22. The liquid image stamping arrangement according to claim 21, when dependent on any one of claim 19 or 20, wherein said stabilizer element is configured to cooperate with said peripheral rim to stabilize said arrangement along with the container upon the support surface.

23. The liquid image stamping arrangement according to any one of claims 21 and 22, wherein said peripheral rim comprises a hydrophobic surface, while the rest of the outlet comprises a hydrophobic surface fluidly connected to the peripheral rim.

24. The liquid image stamping arrangement according to any one of claims 2 to 23, wherein the drainage portion comprises at least one of a ridge, a valley, a channel, a sloped surface, a tunnel, and a textured surface configured to direct liquid therealong.

25. The liquid image stamping arrangement according to claim 24, wherein at least one of said ridge, said valley, said channel, said sloped surface, said tunnel, and said textured surface is formed at an exterior surface of said drainage portion.

26. The liquid image stamping arrangement according to any one of 2 to 25, wherein said drainage portion comprises a tunnel extending at least partially along the longitudinal axis of the container, having an opening facing said stamping portion.

27. The liquid image stamping arrangement according to claim 26, wherein said tunnel extends also at least partially along said radial axis, so as to direct liquid from a side surface of the arrangement to the stamping portion.

28. The liquid image stamping arrangement according to any one of claims 7 to 27, when dependent on claim 7, wherein said stabilizer element comprises at least one container stabilizer arm configured to extend upwardly from said drainage portion for engaging a side surface of the container so as to direct liquid therefrom to the drainage portion.

29. The liquid image stamping arrangement according to claim 28 comprising a series of container stabilizer arms, said arms being peripherally spaced about a periphery of the drainage portion for peripherally stabilizing said container.

30. The liquid image stamping arrangement according to any one of claims 28 and 29, wherein at least one container stabilizer arm is resiliently actuable for resiliently engaging the container.

31. The liquid image stamping arrangement according to any one of claims 28 through 30, wherein at least one container stabilizer arm comprises a ridged surface configured to grip the exterior container surface for enhancing stability of the container when engaged therewith.

32. The liquid image stamping arrangement according to any one of claims 7 to 31, when dependent on claim 7, wherein said stabilizer element is integrally formed with said drainage portion.

33. The liquid image stamping arrangement according to any one of claims 2 to 32, wherein said drainage portion comprises an image-defining element connected thereto by way of at least one bridge element.

34. The liquid image stamping arrangement according to claim 33, when dependent on claim 7, wherein said bridge element is configured above said support plane when the arrangement along with the container is placed on the support surface.

35. The liquid image stamping arrangement according to claim 34 or claim 33, wherein said bridge element is configured so as direct liquid therealong to the stamping portion.

36. The liquid image stamping arrangement according to any one of claims 33 through 35, wherein said image-defining element comprises an element periphery, the element periphery being hydrophilic for attracting aqueous liquid thereto.

37. The liquid image stamping arrangement according to any one of claims 33 through 36, when dependent on claim 18, wherein said image-defining element is connected to said liquid outlet by means of said at least one bridge element, for providing an inner image and an outer image upon the support surface.

38. The liquid image stamping arrangement according to claim 37, wherein the inner image is the same shape as the outer image and centered relative thereto.

39. The liquid image stamping arrangement according to any one of claims 33 to 38, wherein said bridge element has a length of no more than 10 mm, particularly, 5 mm, and yet more particularly 2 mm.

40. The liquid image stamping arrangement according to any one of claims 2 to 39, wherein said arrangement is integrally formed with the container and configured to receive said liquid for directing liquid therethrough.

41. The liquid image stamping arrangement according to any one of the preceding Claims, wherein said arrangement is removably engageable with said container and configured to receive said liquid for directing liquid therethrough.

42. The liquid image stamping arrangement according to any one of the preceding claims wherein said imagery is an advertising logo.

43. A liquid image stamp design process for a container, said container being configured to hold a substance while being placed upon a support surface, whereby a liquid image stamp, liquid having cohesive and adhesive properties firstly positioned at an exterior container surface of said container is configured to be secondly directed through utilization of its cohesive and adhesive properties by said liquid stamp design to form an imagery from said liquid on the support surface, beneath said container, when the container is placed thereupon, said imagery comprising a predetermined, distinct, and recognizable outline, said design process comprising the steps of:
selecting an image shape;
designing a stamping portion configured with a corresponding shape to said image shape;
designing at least one confluence zone adjacent the stamping portion from which liquid can be directed to the stamping portion; and
designing a drainage portion for directing liquid to the at least one confluence zone.

44. The design process according to claim 43, wherein said container has a longitudinal axis oriented vertically when the container is uprightly placed on the support surface, and a radial axis extending perpendicularly to said longitudinal axis; and wherein said liquid image stamp comprises:
a drainage portion configured to extend at least partially along said longitudinal axis of the container so as to utilize at least one of said properties to drain the liquid positioned on the exterior container surface to at least one predetermined confluence zone; and
a stamping portion having a shape corresponding to the distinct and recognizable outline, configured to extend at least partially along the radial axis of the container, and therebeneath, so as to utilize at least one of the properties of the liquid to direct said liquid from the confluence zone along said outline, so as to form said imagery thereby.

45. The design process according to claim 44, wherein said liquid image stamp comprises a bottom image support surface, configured to be placed directly beneath said container, facing said support surface on which said liquid image stamp is placed.

46. The design process according to claim 45, wherein said confluence zone spans, at least in part, on said bottom image support surface.

47. The design process according to any one of claims 44 through 46, wherein said drainage portion comprises hydrophobic surfaces while said stamping portion comprises hydrophilic surfaces.

48. The design process according to any one of claims 45 through 47, when depending on claim 45, wherein the stamping portion protrudes from the bottom image support surface.

49. The design process according to any one of claims 44 to 48, wherein said liquid image stamp comprises at least one stabilizer element configured t stabilize said liquid image stamp along with said container when they are placed on the support surface, said stabilizer element defining a support plane adjacent the support surface, on which said container along with said liquid image stamp is configured to rest, wherein, when the liquid image stamp along with the container are placed on the support surface, said stamping portion is disposed at a height with respect to the support plane being identical to the support plane or slightly above it, so as to allow liquid applied on the stamping portion to spontaneously pass through the support plane to the support surface, when the liquid image stamp is placed on the support surface.

50. The design process according to claim 49, wherein said stabilizer element constitutes a part of said stamping portion.

51. The design process according to any one of claims 48 through 50, wherein said stabilizer element protrudes from the bottom image support surface.

52. The design process according to any one of claims 44 through 51, wherein said stamping portion is asymmetric.

53. The design process according to any one of claims 44 through 52, wherein said drainage portion comprises tunnels extending from the at least one confluence zone.

54. The design process according to any one of claims 44 through 53, wherein said outline is asymmetric.

55. The design process according to any one of claims 44 through 54, wherein said stamping portion is non-continuous.

56. The design process according to claim 55, wherein said stamping portion comprises at least one gap between two adjacent non-continuous portions thereof, said gap having a width being no greater than 10 mm, particularly, 5 mm, and yet more particularly, 2 mm.

57. The design process according to claim 56, wherein said gap comprises a hydrophobic surface.

58. The design process according to any one of claims 44 to 57, wherein said stamping portion is flat.

59. The design process according to any one of claims 44 to 57, wherein said stamping portion comprises at least one rim having a shape corresponding to at least a portion of said outline.

60. The design process according to any one of claims 44 to 59, wherein the drainage portion comprises a liquid outlet having a shape corresponding to said outline so as to shape liquid outletting therethrough for forming said imagery, said outlet being constituted by a through opening in a surface of the liquid image stamp.

61. The design process according to claim 60, when dependent on claim 49, wherein the at least one stabilizer element is configured to at least partially surround said liquid outlet.

62. The design process according to claim 61, wherein said stabilizer element is configured to elevate said container relative to the liquid outlet at a container support plane parallel to the support surface.

63. The design process according to any one of claims 60 through 62, wherein said outlet comprises at least one peripheral rim configured to face said support surface when the liquid image stamp along with the container is placed thereon, said peripheral rim constituting at least a part of said stamping portion.

64. The design process according to claim 63, when dependent on any one of claim 61 or 62, wherein said stabilizer element is configured to cooperate with said peripheral rim to stabilize said liquid image stamp along with the container upon the support surface.

65. The design process according to any one of claims 63 and 64, wherein said peripheral rim comprises a hydrophobic surface, while the rest of the outlet comprises a hydrophobic surface fluidly connected to the peripheral rim.

66. The design process according to any one of claims 44 to 65, wherein the drainage portion comprises at least one of a ridge, a valley, a channel, a sloped surface, a tunnel, and a textured surface configured to direct liquid therealong.

67. The design process according to claim 66, wherein at least one of said ridge, said valley, said channel, said sloped surface, said tunnel, and said textured surface is formed at an exterior surface of said drainage portion.

68. The design process according to any one of 44 to 67, wherein said drainage portion comprises a tunnel extending at least partially along the longitudinal axis of the container, having an opening facing said stamping portion.

69. The design process according to claim 68, wherein said tunnel extends also at least partially along said radial axis so as to direct liquid from a side surface of the liquid image stamp to the stamping portion.

70. The design process according to any one of claims 49 to 69, when dependent on claim 49, wherein said stabilizer element comprises at least one container stabilizer arm configured to extend upwardly from said drainage portion for engaging a side surface of the container so as to direct liquid therefrom to the drainage portion.

71. The design process according to claim 70 comprising a series of container stabilizer arms, said arms being peripherally spaced about a periphery of the drainage portion for peripherally stabilizing said container.

72. The design process according to any one of claims 70 and 71, wherein at least one container stabilizer arm is resiliently actuable for resiliently engaging the container.

73. The design process according to any one of claims 70 through 72, wherein at least one container stabilizer arm comprises a ridged surface configured to grip the exterior container surface for enhancing stability of the container when engaged therewith.

74. The design process according to any one of claims 49 to 73, when dependent on claim 49, wherein said stabilizer element is integrally formed with said drainage portion.

75. The design process according to any one of claims 44 to 74, wherein said drainage portion comprises an image-defining element connected thereto by way of at least one bridge element.

76. The design process according to claim 75, when dependent on claim 49, wherein said bridge element is configured above said support plane when the liquid image stamp along with the container is placed on the support surface.

77. The design process according to claim 76 or claim 75, wherein said bridge element is configured so as direct liquid therealong to the stamping portion.

78. The design process according to any one of claims 75 through 77, wherein said image-defining element comprises an element periphery, the element periphery being hydrophilic for attracting aqueous liquid thereto.

79. The design process according to any one of claims 75 through 78, when dependent on claim 60, wherein said image-defining element is connected to said liquid outlet by means of said at least one bridge element, for providing an inner image and an outer image upon the support surface.

80. The design process according to claim 79, wherein the inner image is the same shape as the outer image and centered relative thereto.

81. The design process according to any one of claims 75 to 80, wherein said bridge element has a length of no more than 10 mm, particularly, 5 mm, and yet more particularly 2 mm.

82. The design process according to any one of claims 44 to 81, wherein said liquid image stamp is integrally formed with the container and configured to receive said liquid for directing liquid therethrough.

83. The design process according to any one of claims 43 through 82, wherein said liquid image stamp is removably engageable with said container and configured to receive said liquid for directing liquid therethrough.

84. The design process according to any one of claims 43 through 83, wherein said imagery is an advertising logo.

85. A container configured to hold a substance, incorporating a collection arrangement whereby liquid having cohesive and adhesive properties firstly placed on an exterior surface of said container can be collected to prevent staining of a support surface on which said container is configured to be placed, the container having a longitudinal axis oriented vertically when the container is uprightly placed on the support surface, and a radial axis extending perpendicularly to said longitudinal axis;
said liquid collecting arrangement comprises:
a collection portion spanning at least partially along said radial axis, configured to enable accumulation of said liquid therein; and
a drainage portion extending at least partially along said longitudinal axis and utilize at least one of said properties to drain the liquid positioned on the exterior container surface to the collection portion.

86. The container according to claim 85, wherein said drainage portion extends along the exterior container surface.

87. The container according to any one of claims 85 and 86, wherein said container has an upper container volume in which liquid can be normally stored, and a lower container volume disposed directly therebeneath, defined by the collection arrangement.
